(19) United States
(12) Patent Application Publication
(10) Pub. No.: US 2014/0247687 A1
(43) Pub. Date: Sep. 4, 2014

(54) FLUID STIRRER, METHOD OF STIRRING FLUID AND METHOD OF PREPARING TONER

(71) Applicants: Tetsu Mizuno, Shizuoka (JP); Yasuyuki Kamei, Shizuoka (JP); Keisuke Tada, Shizuoka (JP); Naoki Takahashi, Shizuoka (JP)

(72) Inventors: Tetsu Mizuno, Shizuoka (JP); Yasuyuki Kamei, Shizuoka (JP); Keisuke Tada, Shizuoka (JP); Naoki Takahashi, Shizuoka (JP)

(73) Assignee: RICOH COMPANY, LTD., Tokyo (JP)

(21) Appl. No.: 14/168,220

(22) Filed: Jan. 30, 2014

(30) Foreign Application Priority Data
Mar. 4, 2013 (JP) 2013-042227
Jun. 27, 2013 (JP) 2013-135242

(51) Int. Cl. B01F 5/06

(52) U.S. Cl. CPC B01F 5/0606
USPC 366/339

(57) ABSTRACT

A static fluid stirrer includes a flow channel pipe passing a fluid inside; a spiral flow forming member guiding the fluid to circle around a central axis parallel to a passing direction of the fluid to form a spiral flow in the flow channel pipe; and a spiral flow baffle member projecting from the inner wall of the flow channel pipe and baffling the spiral flow.

### CROSS-REFERENCE TO RELATED APPLICATIONS

This patent application is based on and claims priority pursuant to 35 U.S.C. §119 to Japanese Patent Applications Nos. 2013-042227 and 2013-135242, filed on Mar. 4, 2013 and Jun. 27, 2013, respectively, in the Japan Patent Office, the entire disclosure of which is hereby incorporated by reference herein.

### BACKGROUND

1. Technical Field

The present invention relates to a static fluid stirrer stirring a fluid having fluidity such as gases, liquids and powders, and a method of stirring fluid and a method of preparing toner using the fluid stirrer.

2. Description of the Related Art

As a conventional static fluid stirrer mixing plural fluids, a stirrer in which connected plural spiral blades having the shape of a twisted flat plate are located in a flow channel pipe a fluid passes through is known as disclosed in Japanese published unexamined application No. JP-H02-43932-A and U.S. Pat. No. 4,408,893.

The fluid stirrer includes a stirrer in which the downstream edge of a flat plate twisted at an angle of from 90 to 180° as a spiral blade as one unit is located at the upstream edge of a following unit at a shifted angle.

FIG. 8A is a perspective view illustrating a blade member 2 which is a spiral blade of a conventional fluid stirrer 10. FIG. 8B is a top view of the blade member 2. FIG. 8C is a cross-sectional view of the fluid stirrer 10 in which the blade member 2 is located in a flow channel pipe 1.

A first blade member 2a which is a flat plate twisted at an angle of 180° and a second blade member 2b which is a flat plate twisted at an angle of 180° in the reverse direction are alternately located. The downstream edge 2a2 of the first blade member 2a is located at the upstream edge 2b1 of the second blade member 2b at a shifted angle of 90°. Similarly, the downstream edge 2b2 of the second blade member 2b is located at the upstream edge 2a1 of the first blade member 2a at a shifted angle of 90°.

A fluid spirally proceeds through flow channels 11a and 11b divided by the blade member 2 while passing the flow channel pipe 1. A flow is divided into two at the upstream edges 2a1 and 2b1 of the blade member 2, and the two flows meet each other at the downstream edges 2a2 and 2b2 thereof. Specifically, a fluid having reached the upstream edges 2a1 of the of the first blade member is divided into the two flow channels 11a and 11b divided by the first blade member 2a and the flows meet each other when having reached the downstream edges 2a2 of the first blade member. At the same time, the flow is divided into a two flow channels divided by the second blade member 2b having the upstream edge 2b1 at a shifted angle of 90° relative to the downstream edges 2a2 of the of the first blade member. Thus, a fluid spirally proceeds while flows thereof are divided and meet each other repeatedly to be stirred.

The fluid stirrer 10 fully stirs plural fluids because a number of the blade members 2 are continuously located. A long flow channel pipe is necessary because a fluid passes a number of the blade members 2, it takes time to complete mixing.

FIG. 9 is a schematic view illustrating a simulation result of passing a fluid through the fluid stirrer 10. Flows of the fluid are indicated by arrows in a cross-section perpendicular to a passing direction thereof. Each of the arrows indicates a moving direction and a moving speed of the fluid at a position. The longer, the faster.

A fluid is guided to form a spiral flow by the blade member 2 and moves circling around a central axis of the flow channel pipe 1 in a cross-section perpendicular to a passing direction thereof. The fluid moves slow in a radial direction of the flow channel pipe 1, and the fluid moving near an inner wall thereof tends to move near the inner wall and the fluid moving near the center thereof tends to move near the center thereof. Therefore, fluids located nearby each other are difficult to separate from each other as time passes, i.e., difficult to stir. As a result, a long flow channel pipe is needed and it takes time to complete mixing.

This is not only a problem for a case where a member spirally proceeding a fluid is a spiral blade having the shape of a twisted flat plate, but also for a static fluid stirrer equipped with a spiral flow forming member guiding a fluid to form a spiral flow in a flow channel pipe.

Because of these reasons, a need exists for a static fluid stirrer capable of efficiently stirring a fluid in a shorter flow channel pipe.

### SUMMARY

Accordingly, one object of the present invention is to provide a static fluid stirrer capable of efficiently stirring a fluid in a shorter flow channel pipe.

Another object of the present invention is to provide a method of stirring a fluid using the static fluid stirrer.

A further object of the present invention is to provide a method of preparing toner using the static fluid stirrer.

These objects and other objects of the present invention, either individually or collectively, have been satisfied by the discovery of a static fluid stirrer, including a flow channel pipe passing a fluid inside; a spiral flow forming member guiding the fluid to circle around a central axis parallel to a passing direction of the fluid to form a spiral flow in the flow channel pipe; and a spiral flow baffle member projecting from the inner wall of the flow channel pipe and baffling the spiral flow.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1A is a perspective view illustrating an embodiment of the blade member and the baffle plate of the fluid stirrer of the present invention, and FIG. 1B is a cross-sectional view illustrating an embodiment of the fluid stirrer including the blade member and the baffle plate in the flow channel pipe;

FIG. 2 is a schematic view illustrating a mixer mixing a dispersion of toner core particles and a dispersion of resin particles B in a process of transferring the resin particles B;

FIG. 3 is a schematic view illustrating an example of a simulation result of passing a fluid through the fluid stirrer in FIGS. 1A and 1B;

FIG. 4A is a schematic view illustrating an example in which particles are well mixed in a mixed liquid, and FIG. 4B is a schematic view illustrating an example in which particles aggregate;

FIG. 5 is a schematic view illustrating an embodiment of the fluid stirrer in which the baffle plate is spirally located on an inner circumferential surface of the flow channel pipe;

FIGS. 6A and 6B are schematic views illustrating an embodiment of the fluid stirrer equipped with a flow channel limiting plate;

FIG. 7 is a schematic view illustrating an embodiment of the fluid stirrer in which an outer diameter of the blade member is equal to an inner diameter of the flow channel pipe;

FIG. 8A is a perspective view illustrating a blade member of a conventional fluid stirrer, FIG. 8B is a top view of the blade member, and FIG. 8C is a cross-sectional view of the fluid stirrer in which the blade member is located in a flow channel pipe;

FIG. 9 is a schematic view illustrating a simulation result of passing a fluid through the conventional fluid stirrer;

FIG. 10 is a schematic view illustrating an embodiment of the mixer used in toner preparation method of Modified Example; and

FIG. 11 is a schematic view illustrating a mixer used in conventional toner preparation method.

### DETAILED DESCRIPTION

The present invention provides a static fluid stirrer capable of efficiently stirring a fluid in a shorter flow channel pipe.

Embodiments of using the fluid stirrer of the present invention in processes of mixing plural toner materials when preparing a polymerization toner are explained.

Processes of preparing the polymerization toner include an oil phase preparation process, an emulsification process, a de-solvent process, a washing and drying process and an external additive application process.

### <Oil Phase Preparation Process>

The oil phase preparation process prepares an oil phase in which a resin and a colorant are dissolved or dispersed in an organic solvent. A method of preparing the oil phase includes gradually adding and dissolving or dispersing them in the organic solvent while stirred. However, when a pigment is used as a colorant, or when a release agent or a charge controlling agent which is difficult to dissolve in an organic solvent is added, they are preferably downsized before added therein. The colorant may be included in a masterbatch mentioned later, and the release agent or the charge controlling agent may be included therein as well.

A colorant, a release agent and a charge controlling agent may be dispersed in an organic solvent with a dispersion aid when necessary to prepare a wet master.

When a material soluble at less than a boiling point of an organic solvent is dispersed, it may be heated in an organic solvent while stirred with a dispersoid when necessary to be dissolved therein, and the solution is cooled while stirred o sheared to be crystallized and form a fine crystal of the dispersoid. A colorant, a release agent and a charge controlling agent dissolved or dispersed with a resin in an organic solvent may further be dispersed. Known dispersers such as beads mills and disc mills can be used when dispersing them.

### <Emulsification Process>

The emulsification process disperses an oil phase in an aqueous medium including at least a surfactant to prepare a dispersion in which core particles formed of oil phase are dispersed. Methods of preparing the dispersion are not particularly limited, and include using known dispersers such as low-speed shearing dispersers, high-speed shearing dispersers, friction dispersers, high-pressure jet dispersers and ultrasonic dispersers. The high-speed shearing dispersers are preferably used in order that dispersed particles have a particle diameter of from 2 to 20 μm. The high-speed shearing dispersers are not particularly limited in rpm, but preferably from 1,000 to 30,000 rpm, and more preferably from 5,000 to 15,000 rpm.

The dispersion time is not particularly limited, but preferably from 1 to 5 min in batch methods. When longer than 5 min, undesired small-size particles remain or particles are dispersed too much and the dispersion becomes unstable, resulting in formation of aggregates and coarse particles. When less than 1 min, uniformity of the resultant particles is low and a desired distribution is difficult to obtain.

The dispersion temperature is preferably from 10 to 40° C., and more preferably from 15 to 25° C. When higher than 40° C., molecular movement becomes active and dispersion becomes unstable, resulting in formation of aggregates and coarse particles. When less than 10° C., shearing energy needed for dispersing increases, resulting in lowering of production efficiency.

### <Resin Particles B Transfer Process>

A dispersion of resin particles B mentioned later such as vinyl resins is mixed with the dispersion of toner core particles prepared in the emulsification process. Core particle droplets can stably be present in the core particle dispersion while fed in the pipings. Then, the dispersion of resin particles B mentioned later is placed to adhere on the core particles.

In this embodiment, the fluid stirrer of the present invention is used to mix the dispersion of resin particles B with the dispersion of toner core particles.

The fluid stirrer of the present invention transfers the resin particles B onto the core particles such that the resin particles B adhere thereto with adequate strength. It is thought this is because when the resin particles B adheres to the core particle droplets, the core particles are freely deformable and form sufficient interface with the resin particles B. Further, since the resin particles B swell or dissolve with an organic solvent, it is likely they adhere with each other.

An organic solvent is effectively added to the dispersion of core particles after the resin particles B or the dispersion of resin particles B is added thereto. The organic solvent promotes swelling or dissolution of the surface of the resin particles B or the core particles, and they are likely to adhere with each other well.

When the resin particles B are added while dispersed in pure water, an organic solvent in the core particles is dissolved in pure water and the resin particles B deteriorates in adherence. However, the additional organic solvent prevents the resin particles B from deteriorating in adherence. An additional amount of the organic solvent is preferably from 5 to 50% by weight, and more preferably from 10 to 30% by weight, based on total weight of the core particles. When less than 5% by weight, there is almost no effect of swelling or dissolution of the resin particles. When greater than 50% by weight, production efficiency of colored resin particles deteriorates and dispersion stability of the core particles deteriorates, resulting in coarse particles. Therefore, yield rate lowers and stable production is difficult to make.

The organic solvent is preferably added in not less than 20 sec. When less than 20 sec, the core particles temporally and locally includes an organic solvent having a concentration higher than desired, resulting in generation of agglomerated particles. Meanwhile, it is not preferable to take time than necessary, e.g., longer than 60 min to add the organic solvent in terms of production efficiency. In order to prevent the core particles from temporally and locally including an organic solvent having a concentration higher than desired, besides gradually adding the organic solvent, split placement, showering, methods of continuously mixing while controlling flow amount can be used.

Specific examples of the organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These solvents can be used alone or in combination. Particularly, the same organic solvent used in the oil phase preparation process is preferably used.

Next, pure water is effectively placed to fix the resin particles B on the surface layer of the core particles. In the production site, the particles are not stirred for not less than 10 hrs from the resin particles B transfer process to the de-solvent process occasionally. During this time, the resin particles may be released from the surface layer of the core particles or buried too deep therein. Pure water is added to the dispersion of core particles the resin particles B adhere to and a concentration of the organic solvent in the dispersion is lowered to promote fixation of the resin particles B on the surface of the core particles and prevent them from being buried too deep in the core particles. Pure water is preferably included in the dispersion of core particles after an organic solvent is included therein in amount of from 25 to 200% by weight, and more preferably from 75 to 125% by weight, based on total weight of the core particles. When less than 25% by weight, the concentration of the organic solvent is not sufficiently lowered and the resin particles B has low adherence. When greater than 200% by weight, colored resin particles decrease in a process and production efficiency lowers.

Pure water is preferably added in 30 min, and more preferably in 15 min after the organic solvent is added. When added after 30 min or more pass, pure water has less effect and the resin particles B has low adherence. Pure water includes, but is not limited to, ion-exchanged water, distilled water, RO water and ultrapure water.

Methods of adding the organic solvent and pure water in the dispersion of core particles include, but are not limited to, batch methods of adding them while stirring them in a container storing the dispersion of core particles and methods of continuously mixing them into the dispersion with a static mixer or the like while controlling the flow amount.

The dispersion of resin particles B may be diluted or condensed to adjust the concentration before placed in the dispersion of core particles. The dispersion of resin particles B preferably has a concentration of from 5 to 30% by weight, and more preferably from 8 to 20% by weight. When less than 5% by weight, the organic solvent largely varies in concentration and adherence of the resin particles B is insufficient. When greater than 30% by weight, the resin particles B are likely to be eccentrically located in the dispersion of core particles, resulting in agglomerated core particles and non-uniform adherence of the resin particles B.

The resin particles B preferably adhere to the core particles at from 10 to 60° C., and more preferably from 20 to 45° C. When higher than 60° C., production energy increases and environmental load is large. In addition, the resin particles B having low acid value are present on the surface of a droplet and unstably dispersed, which may cause coarse particles. When less than 10° C., the dispersion has high viscosity, resulting in insufficient adherence of the resin particles B.

### <De-Solvent Process>

The de-solvent process removes the organic solvent from the colored resin dispersion obtained in the emulsification process. Methods of removing the organic solvent include gradually heating the dispersion while stirring the dispersion to completely remove the organic solvent in a droplet evaporatively. Alternatively, the colored resin dispersion may be sprayed in a dry atmosphere while stirred to completely remove the organic solvent in a droplet. Further, the colored resin dispersion may be depressurized while stirred to evaporatively remove the organic solvent. Each of the latter two methods can be combined with the former method.

The dry atmosphere includes gases such as heated air, nitrogen, carbon dioxide and combustion gas. Particularly, gases heated to have a temperature not less than a boiling point of the solvent used are typically used. A spray drier, a belt drier, a rotary kiln, etc, can be used.

### <Aging Process>

When a modified resin having an isocyanate group is included at the end, an aging process may be performed to proceed elongation or crosslinking reaction of the isocyanate. The aging time is typically from 10 min to 30 hrs, and preferably from 2 to 15 hrs. The reaction temperature is typically from 20 to 65° C., and preferably from 35 to 50° C.

### <Washing and Drying Process>

Known methods are used to wash and dry the toner particles dispersed in an aqueous medium obtained in the de-solvent process. Namely, subjecting the toner particles dispersed in an aqueous medium to a solid-liquid separation with a centrifugal separator or a filter press to prepare a toner cake; dispersing again the toner cake in ion-exchange water having a room temperature to 40° C. while controlling pH with an acid or an alkali when necessary; repeating subjecting the toner cake to a solid-liquid separation for several times to remove impurities or surfactant therefrom; and drying the toner cake with a drier such as a flash drier, a circulation drier, a decompression drier and a vibration fluidization drier to prepare a toner powder. Fine toner particles may be removed therefrom with a centrifugal separator or the toner powder can have a desired particle diameter distribution with a known classifier when necessary.

### <External Additive Application Process>

Heterogeneous particles such as release agent particles, charge controlling particles, fluidizing particles and colorant particles can be mixed with a toner powder after dried. Release of the heterogeneous particles from composite particles can be prevented by giving a mechanical stress to a mixed powder to fix and fuse them on a surface of the composite particles.

Specific methods include a method of applying an impact strength on a mixture with a blade rotating at a high-speed, a method of putting a mixture in a high-speed stream and accelerating the mixture such that particles thereof collide each other or composite particles thereof collide with a collision board, etc.

Specific examples of the apparatus include, but are not limited to, NOBILTA from Hosokawa Micron Corp., METEORAINBOW from Nippon Pneumatic Mfg. Co., Ltd. and a hybridization system from Nara Machinery Co., Ltd.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

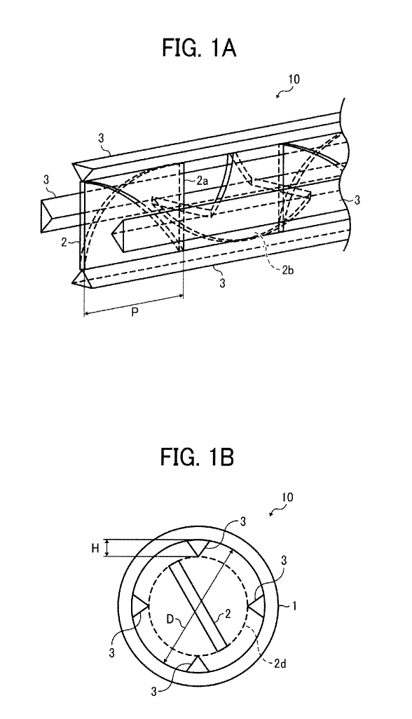

FIG. 1A is a perspective view illustrating an embodiment of the blade member 2 and the baffle plate 3 of the fluid stirrer 10 of the present invention, and FIG. 1B is a cross-sectional view illustrating an embodiment of the fluid stirrer 10 including the blade member 2 and the baffle plate 3 in the flow channel pipe 1.

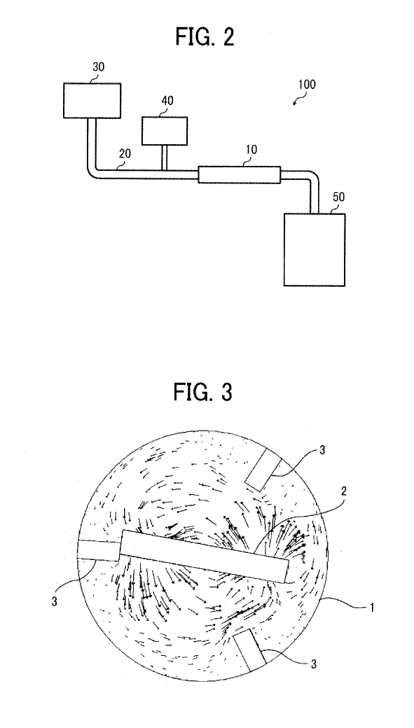

FIG. 2 is a schematic view illustrating a mixer 100 mixing a dispersion of toner core particles and a dispersion of resin particles B in a process of transferring the resin particles B.

The mixer 100 in FIG. 2 includes a core particle liquid container 30 containing a dispersion of core particles of a toner, a resin particle liquid container 40 containing a dispersion of resin particles B, a junction pipe 20, the fluid stirrer 10 and a mixed liquid container 50.

The mixer 100 provides the dispersion of core particles of a toner from the core particle liquid container 30 into the junction pipe 20 at a constant flow amount, and the dispersion of resin particles B from the resin particle liquid container 40 thereinto at a constant flow amount. Thus, a mixed liquid including the dispersion of core particles of a toner and the dispersion of resin particles B at a constant rate is fed from the junction pipe 20 to the fluid stirrer 10.

The mixed liquid is stirred in the fluid stirrer 10 such that the dispersion of core particles of a toner and the dispersion of resin particles B are uniformly mixed therein to be fed into the mixed liquid container 50.

The fluid stirrer 10 is a static fluid stirrer including a flow channel pipe 1 through which a fluid mixed liquid passes and a blade member 2 which is a spiral flow forming member guiding the mixed liquid so as to form a spiral flow. The spiral flow the mixed liquid forms circles around a central axis parallel to a passing direction (right and left direction in FIG. 2 and a direction perpendicular to FIG. 1B) of the flow. Further, the fluid stirrer 10 includes a baffle plate 3 which is a spiral flow baffle member projecting inward from the inner wall surface of the flow channel pipe 1 and baffling the spiral flow the blade member 2 forms.

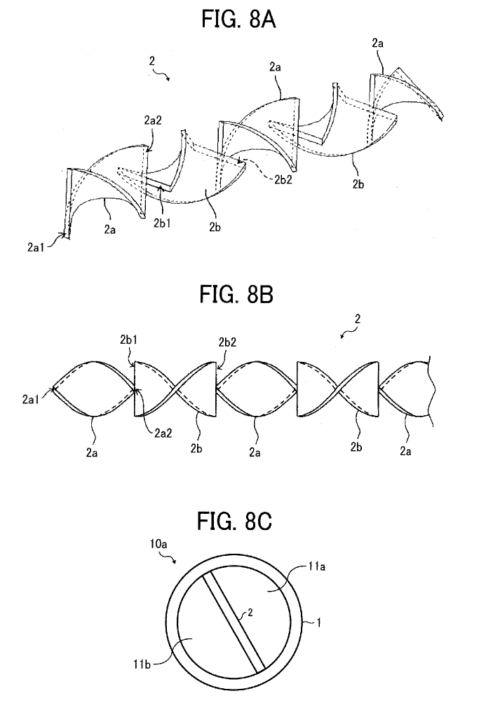

Namely, compared with the conventional fluid stirrer 10 in FIG. 8, the fluid stirrer 10 in FIGS. 1A and 1B further include the baffle plate 3 in a space between the blade member 2 and the flow channel pipe 1.

The flow channel pipe I of the fluid stirrer 10 preferably has the shape of a cylinder. The blade member 2 of the fluid stirrer 10 in FIGS. 1A and 1B is divided every time when twisted at 180°, and the edges of adjacent first blade member 2a and second blade member 2b intersect with other. Further, twist directions of the first blade member 2a and the second blade member 2b are reversed each other. Thus, the blade member 2 of the fluid stirrer 10 is preferably has repeated constitutions in which twisted flat plates intersect, reverse twist directions and are connected with each other every time when twisted at from 90 to 270°.

The static fluid stirrer 10 can be used for stirring and mixing fluids besides a mixed liquid in which toner materials are mixed with each other. In particular, the blade member preferably divides itself, intersects the edges of the divided parts and repeats reversing twist directions thereof every time when twisted at 90° for a low-viscosity fluid, and 180° for a high-viscosity fluid.

When an inner diameter of the flow channel pipe 1 is D and a pitch of the blade member 2 (a length of the first blade member 2a or the second blade member 2b) is P, P/D is preferably from 1.0 to 2.0, and more preferably 1.0. When the baffle plate 3 has a height H to the center of the axis, H/D is preferably from 0.05 to 0.2, and more preferably 0.1.

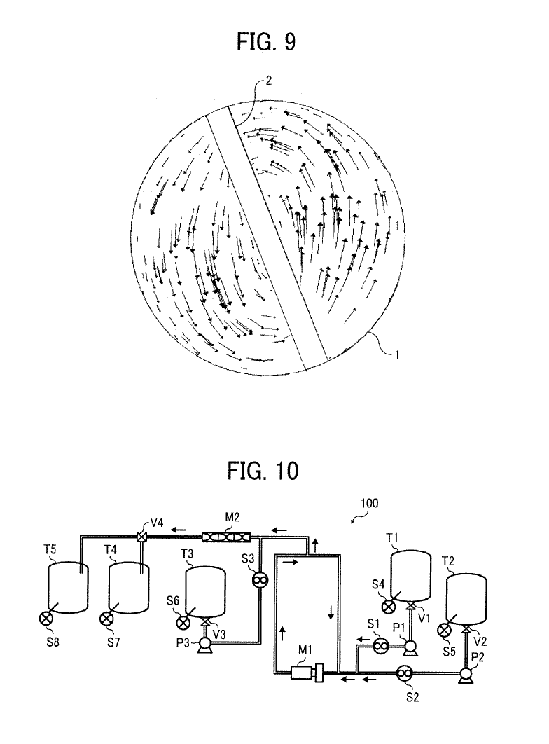

FIG. 3 is a schematic view illustrating an example of a simulation result of passing a fluid through the fluid stirrer 10 in FIGS. 1A and 1B. The simulation in FIG. 3 is performed under the same conditions as those of the simulation of the conventional fluid stirrer 10 in FIG. 9 except that a baffle plate 3 is located and the blade member 2 is shortened by a height of the baffle plate 3.

In FIG. 3, a direction and a size of an arrow represent a moving direction and a moving speed of a fluid at a position. The longer the arrow, the faster the speed.

The baffle plate 3 of the fluid stirrer 10 in FIGS. 1A and 1B has a triangular cross-sectional shape, and that in FIG. 3 has a quadrangular cross-sectional shape.

In the fluid stirrer 10 in FIGS. 1A and 1B, the fluid is guided by the blade member 2 to form a spiral flow and circles around the central axis of the flow channel pipe 1. However, since the baffle plate 3 baffles circling of the fluid, as the cross-section perpendicular to the passing direction in FIG. 3 shows, the fluid has a faster moving speed in a radial direction of the flow channel pipe 1 than the simulation in FIG. 9. Thus, the fluid flowing near the inner wall of the flow channel pipe 1 partially flows to the center thereof and the fluid flowing near the center thereof partially flows to the inner wall thereof. Therefore, the fluids located nearby each other at a time noticeably separate from each other as time passes, and stirring is more efficiently performed than the fluid stirrer 10 in FIG. 9.

A problem of the resin particles B transfer process when the fluid s er of the present invention is not used is explained.

In the resin particles B transfer process, a dispersion of resin particles such as vinyl resins is mixed in the dispersion of core particles of a toner obtained in the emulsification process. The resin particles are mixed to improve chargeability and stress resistance of the resultant toner.

However, when there is a part where the concentration of the dispersion of resin particles is high in a liquid in which the dispersion of core particles of a toner and the dispersion of resin particles are mixed with each other, the core particles of a toner are likely to aggregate each other.

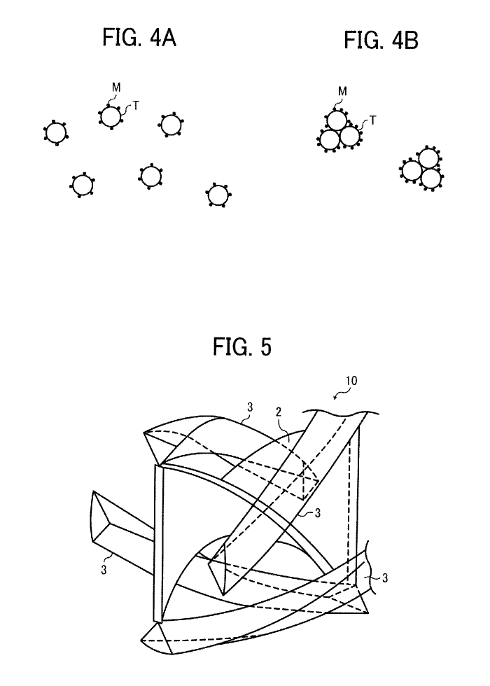

FIG. 4A is a schematic view illustrating an example in which particles are well mixed in a mixed liquid, and FIG. 4B is a schematic view illustrating an example in which particles aggregate. As FIG. 4A shows, core particles T of a toner are separate from each other and particles M adhere to the surface thereof when well mixed. Plural core particles T of a toner aggregate and the particles M adhere to the aggregate when mot well mixed.

Since the aggregation causes deterioration of the quality the resultant toner and yield rate thereof, it is desired that the dispersion of resin particles is uniformly mixed in the dispersion of core particles of a toner without uneven concentration so as not to aggregate right after mixed.

Methods of preventing aggregation include a method of filling the dispersion of core particles of a toner in a stirring container equipped with a rotational stirring member in a predetermined amount, and providing the dispersion of resin particles therein until having a predetermined rate relative to that of the dispersion of core particles of a toner while the stirring member rotates.

This method increases the concentration of the dispersion of resin particles in the mixed liquid as time passes, but a small amount thereof is fed at a time and stirred by the stirring member soon after fed. Therefore, a part where the concentration of the dispersion of resin particles is high is not formed in the mixed liquid.

However, this method needs an exclusive power for stirring, which causes high cost. Further, it takes time to store the dispersion and the mixed liquid in the stirring container, which causes deterioration thereof and lower yield rate.

Mixing methods needing no power and preventing deterioration of the fluid and lower yield rate due to storage of the fluid include a method of using a static fluid stirrer. The fluid includes not only a liquid and a gas, but also a powder having fluidity.

As a static fluid stirrer mixing fluids, a stirrer in which connected plural spiral blades are located in a pipe is known as disclosed in Japanese published unexamined application No. JP-H02-43932-A and U.S. Pat. No. 4,408,893. In the fluid stirrer, a fluid spirally passes a flow channel partitioned by blades and is divided at each border of the blades. Then, the divided fluids join at the end of each blade again to be stirred. In addition, Japanese published unexamined application No. JP-2005-305219-A discloses a fluid stirrer including an auxiliary on an inner wall circumference of a passage pipe or a part a fluid passage structure to increase strength of shearing the fluid. Further, Japanese published examined application No. JP-H02-004334-B discloses a fluid stirrer including a cylindrical passage pipe, on the inner wall of which spiral grooves are carved, and a spiral axis, on the outer wall of which proper number of spiral grooves are carved, inserted in the pipe.

However, in the fluid stirrer disclosed in Japanese published unexamined application No. JP-H02-43932-A and U.S. Pat. No. 4,408,893, depending on a viscosity or a difference of viscosity, the fluid flowing near the inner wall of a pipe tends to flow near the inner wall, and the fluid flowing near the center of the pipe tends to flow near the center. In the fluid stirrers disclosed in Japanese published unexamined application No. JP-2005-305219-A and Japanese published examined application No. JP-H02-004334-B, the fluids flowing near the inner wall and the center of the pipe do not frequently exchange with each other because the fluid tends to pass a place where the resistance is small.

These stirrers are connected with each other to effectively stir a fluid. However takes time for a fluid to pass the stirrer and the stirrer become long.

When the stirrer becomes longer, not only it is difficult to secure a space to locate or operate the stirrer, but also maintainability thereof becomes worse because the fluid stirrer periodically needs maintenance such as washing since an additive adheres to the inside of the stirrer, depending on the fluid. Like mixing of a resin and a hardener, when the faster the mixing the better the quality of the resultant product, the connected long stirrer does not improve quality.

When the long stirrer is used in the resin particle B transfer process, a part where the concentration of the dispersion of resin particles is high in a mixed liquid takes time to disappear and aggregates are formed.

The fluid stirrer 10 of the embodiment in FIGS. 1A and 1B baffles a spiral flow with the baffle plate 3 to effectively stir the fluid, and is capable of forming the static fluid stirrer shorter than conventional. The fluid stirrer can shorten the mixing time and prevents aggregates from forming when used in the resin particle B transfer process.

The fluid stirrer 10 of the embodiment can mix not only toner materials but also other fluids more effectively than conventional. Further, the fluid stirrer can mix not only fluids such as gas and liquid, but also can mix powdery toner particles with a powdery external additive. The fluid stirrer not only mixes plural fluids, but also prevents aggregates from forming.

The blade member 2 of the fluid stirrer 10 in FIGS. 1A and 1B is a spiral blade having the shape of a flat plate twisted on a central axis. The central axis is a virtual straight line passing the center of a circular cross-section of the flow channel pipe 1. The spiral flow forming member guiding a fluid so as to circle around the central axis parallel to a passing direction thereof to form a spiral flow is not limited to the blade member 2. Any members forming a spiral flow of a fluid may be used, such as a screw-shaped member having a spiral blade on a shaft member extending through the central axis.

In the fluid stirrer 10 in FIGS. 1A and 1B, the baffle plate 3 has the shape of a straight line parallely extending relative to a passing direction of a fluid.

The shape of the baffle plate 3 is not limited to a straight line, and as FIG. 5 shows, the baffle plate 3 may spirally be located on an inner circumferential surface of the flow channel pipe 1 such that a location thereof changes according to a position in the flow channel pipe 1.

In FIG. 5, when the baffle plate 3 has an extending direction parallel to a twist direction of the blade member 2, a distance therefrom to the baffle plate 3 in the passing direction does not change and the effect of the baffle plate 3 baffling the spiral flow decreases. Therefore, it is desired that the baffle plate 3 has an extending direction inclined to a twist direction of the blade member 2.

In the fluid stirrer 10 in FIGS. 1A and 1B, the baffle plate 3 has the shape of a straight line. The extending direction of the baffle plate 3 parallel to the central axis is inclined to the twist direction of the blade member 2. Thus, the baffle plate 3 baffles the spiral flow.

The shape of the baffle plate 3 is not limited to a straight line as FIG. 5 shows, but in terms of production simplicity, the baffle plate 3 preferably has a linear shape such as a square bar and a triangle bar.

In the fluid stirrer 10 in FIGS. 1A and 1B, the baffle plate 3 is located outside of a virtual circle 2d an end of the blade member 2 in a radial direction passes through. The end of the blade member 2 in a radial direction contacts an inner end of the baffle plate 3. In a space between an inner circumferential surface of the flow channel pipe 1 and the virtual circle 2d where the baffle plate 3 is not located, there is a short pass where a fluid does not form a spiral flow and passes the flow channel pipe 1 as a flow parallel to the central axis. A fluid may not be stirred as desired due to the short pass.

Therefore, when the baffle plate 3 is located outside of a virtual circle 2d, the short pass is preferably prevented.

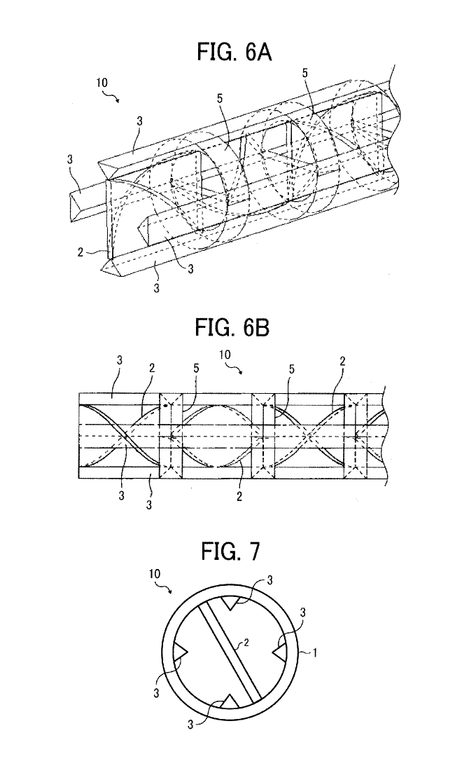

FIG. 6A is a perspective view illustrating an embodiment of the fluid stirrer 10 including a blade member 2, a baffle plate 3 and a flow channel limiting plate 5. FIG. 6B is a side view illustrating the blade member 2, the baffle plate 3 and the flow channel limiting plate 5 in FIG. 6A. A ring-shaped flow channel limiting plate 5 is located at a part of a unit of the blade members 2 connected with each other. The flow channel limiting plate 5 has a cross-section having the shape of a triangular ring. A center of the passing (right and left direction in FIG. 6B) direction of a fluid is a peak of the triangle, where the ring has the smallest inner diameter. The flow channel limiting plate 5 has an outer diameter which is an inner diameter of the flow channel pipe 1, and the smallest inner diameter thereof is an outer diameter of the blade member 2.

The flow channel limiting plate 5 in FIGS. 6A and 6B blocks an area where there may be a short pass in FIGS. 1A and 1B, and stirring is more efficiently be performed.

The flow channel limiting plate 5 preferably has the shape of a ring when the flow channel pipe 1 has the shape of a cylinder, and a circular form according to the cross-sectional form of the flow channel pipe 1 otherwise.

A flow channel cross-section limiting member narrowing a flow channel as the flow channel limiting plate 5 baffles a spiral flow formed by the blade member 2, and has a function of a spiral flow baffling member as well.

As FIG. 7 shows, the blade member 2 located such that an outer diameter thereof is an inner diameter of the flow channel pipe 1 prevents the short pass as well. In this case, one of the blade member 2 and the baffle plate 3 has a notch, and the other is engaged therein. In FIG. 7, the blade member 2 contacts an inner circumferential surface of the flow channel pipe 1 to prevent a short pass passing near the inner circumferential surface of the flow channel pipe 1 and necessity of locating the flow channel limiting plate 5 in FIGS. 6A and 6B decreases.

To improve stirrability with a flow different from the spiral flow of the fluid, the blade member 2, the baffle plate 3 and the flow channel limiting plate 5 may have holes a fluid can pass through. The fluid guided thereby and the fluid passing the holes move through routes different from each other. The fluids located nearby each other at a time are separated into those guided by the blade member 2, the baffle plate 3 and the flow channel limiting plate 5 and those passing the holes. They are easy to leave from each other and stirrability thereof improves.

Next, materials and processes for preparing the toner of the embodiment are specifically explained.

Specific examples of the resin particles B include polyester resins, vinyl resins obtained by polymerizing a monomer mixture including at least a styrene monomer or hybrid resins formed of a polyester resin skeleton having vinyl resin components. In consideration of compatibility with a wax dispersed at the surface of a toner, the vinyl resins are preferably used.

When the colored resin particles prepared in the toner preparation process of the embodiment is used as a toner for developing an electrostatic latent image, they are preferably chargeable with ease. For this, they preferably include styrene monomers having an electron orbit an electron is stably present on like an aromatic ring in an amount of from 50 to 100% by weight, more preferably from 80 to 100% by weight, and furthermore preferably from 95 to 100% by weight based on total weight of monomer mixtures. When less than 50% by weight, the resultant colored resin particles has low chargeability and applications thereof are limited.

The resin particles B preferably has a volume-average particle diameter of from 60 to 120 nm, more preferably from 60 to 110 nm, and furthermore preferably from 60 to 100 nm. When larger than 120 nm, they are not uniformly dispersed on the core particles. When less than 60 nm, they lower in aggregability and floating particles increase, resulting in deterioration of uniformity of the resin particles B dispersed on the core particles. In the embodiment, the resin particles B having a volume-average particle diameter of from 60 to 120 nm can uniformly be dispersed on the core particles.

The styrene monomer is an aromatic compound having a vinyl polymerizable functional group. Specific examples of the polymerizable functional group include, but are not limited to, vinyl groups, isopropenyl groups, allyl groups, acryloyl groups, methacryloyl groups.

Specific examples of the monomer include, but are not limited to, styrene, α-methylstyrene, 4-methylstyrene, 4-ethylstyrene, 4-tert-butylstyrene, 4-methoxystyrene, 4-ethoxystyrene, 4-carboxystyrene or its metallic salts, 4-styrenesulfonate or its metallic salts, 1-vinylnaphthalene, 2-vinylnaphthalene, allylbenzene, phenoxyalkyleneglycolacrylate, phenoxyalkyleneglycolmethacrylate, phenoxypolyalkyleneglycolacrylate, phenoxypolyalkyleneglycolmethacrylate, methoxydiethyleneglycolmethacrylate. Among these, styrene is preferably used because of being easily obtainable, and having good reactivity and high chargeability.

The vinyl resins may include an acidic monomer in an amount of from 0 to 7% by weight based on total weight of the monomer mixture. The content of the acidic monomer is preferably 0 to 4% by weight, and more preferably zero. When the acidic monomer is used in an amount greater than 7% by weight, the resultant vinyl resin particles have high dispersion stability. Even when the vinyl resin particles added to a dispersion in which oil drops are dispersed in an aqueous phase, they are difficult to adhere at normal temperature or likely to release even when having adhered. They are easily released in the processes of removing a solvent, washing, drying and applying an external additive.

When not greater than 4% by weight, the resultant toner has less variation in chargeability due to environment. The acidic monomer is a compound having a vinyl polymerizable functional group and an acidic group. Specific examples of the acidic group include, but are not limited to, a carboxylic acid, a sulfonyl acid, and a phosphoryl acid.

Specific examples of the acidic monomer include, but are not limited to, vinyl monomers including a carboxyl group and their salts such as (meth)acrylic acids, maleic acid anhydrides, monoalkyl maleate, fumaric acids, monoalkyl fumarate, crotonic acids, itaconic acids, monoalkyl itaconate, glycol monoether itaconate, citraconic acids, monoalkyl citraconate and cinnamic acids; vinyl monomers including a sulfonic acid group and vinyl monoester sulfate and their salts; vinyl monomers including a phosphoric acid group and their salts.

Among these, (meth)acrylic acids, maleic acid anhydrides, monoalkyl maleate, fumaric acids and monoalkyl fumarate are preferably used.

Methods of obtaining the vinyl resin particles B are not particularly limited, and include the following (a) to (f).

(a) A monomer mixture is polymerized by polymerization methods such as suspension polymerization methods, emulsification polymerization methods, seed polymerization methods and dispersion polymerization methods to prepare resin particles.

(b) A monomer mixture is previously polymerized to prepare a resin, and the resin is pulverized by mechanically rotational or jet pulverizers and classified to prepare resin particles.

(c) A monomer mixture is previously polymerized to prepare a resin, the resin is dissolved in a solvent to prepare a resin solution, and the resin solution is sprayed to prepare resin particles.

(d) A monomer mixture is previously polymerized to prepare a resin, the resin is dissolved in a solvent to prepare a resin solution, and a solvent is added to the resin solution or the resin solution previously heated and dissolved in a solvent is cooled to precipitate resin particles, and a solvent is removed to prepare resin particles.

(e) A monomer mixture is previously polymerized to prepare a resin, the resin is dissolved in a solvent to prepare a resin solution, and the resin solution is dispersed in an aqueous medium under the presence of a suitable dispersant to prepare a dispersion, and the solvent is removed therefrom by heating or depressurizing.

(f) A monomer mixture is previously polymerized to prepare a resin, the resin is dissolved in a solvent to prepare a resin solution, a suitable emulsifier is dissolved in the resin solution, and water is added thereto to perform phase-transfer emulsification.

Among these, (a) is preferably used because resin particles are easily prepared and obtained as a dispersion smoothly applicable to the following process.

In (a), a dispersion stabilizer is added in an aqueous medium or a monomer capable of imparting dispersion stability to the polymerized resin particles (a reactive emulsifier) is added in a monomer to be polymerized, or these two methods are combined to impart dispersion stability to the resultant vinyl resin particles B.

Without dispersion stabilizers and reactive emulsifiers, vinyl resins cannot be obtained as particles because of being incapable of keeping them dispersed, the resultant resin particles do not have enough preservation stability and agglutinate while stored because of having low dispersion stability, or core particles are likely to agglutinate or combine with each other in a resin particle application process mentioned later and the resultant toner has poor uniformity of particle diameter, shape and surface.

Specific examples of the dispersion stabilizers include surfactants and inorganic dispersants.

Specific examples of the surfactants include anionic surfactants such as alkylbenzene sulfonate, α-olefin sulfonate and ester phosphate; amine salts such as alkyl amine salts, amino alcohol fatty acid derivatives, polyamine fatty acid derivatives and imidazoline; quaternary ammonium salt cationic surfactants such as alkyltrimethylammonium salts, dialkyldimethylammonium salts, alkyl dimethyl benzyl ammonium salts, pyridinium salts, alkyl isoquinolinium salts and benzetonium chloride; nonionic surfactants such as fatty acid amide derivatives and polyol derivatives; and amphoteric surfactants such as alanine, dodecyl(aminoethyl)glycin, di(octylaminoethyl)glycin and N-alkyl-N,N-dimethylammonium betaine.

Specific examples of the inorganic dispersants, but are not limited to, include tricalcium phosphate, calcium carbonate, titanium oxide, colloidal silica, hydroxy apatite, etc.

Typical chain-transfer agents can be used when the resin particles B are prepared to control molecular weight thereof. The chain-transfer agents are not particularly limited, and alkyl mercaptan chain-transfer agents having three or more carbon atoms are preferably used.

Specific examples of the hydrophobic alkyl mercaptan chain-transfer agents having three or more carbon atoms include, but are not limited to, butane thiol, octane thiol, decane thiol, dodecane thiol, hexadecane thiol, octadecane thiol, cyclohexyl mercaptan, thiophenol, octyl thioglycolate, octyl 2-mercaptopropionate, octyl 3-mercaptopropionate, 2-ethylhexylester mercaptopropionate, 2-mercaptoethylester octanoate, 1,8-dimercapto-3,6-dioxaoctan, decanetrithiol, dodecylmercaptan.

The hydrophobic chain-transfer agents may be used alone or in combination. The content of the chain-transfer agents is not particularly limited if the resultant copolymer has a desired molecular weight, and preferably from 0.01 to 30 parts by weight, and more preferably from 0.1 to 25 parts by weight based on total molecular weight of the monomer components.

When less than 0.01 parts by weight, the resultant copolymer has too much molecular weight, and the resultant toner possibly deteriorates in fixability and gelates during the polymerization reaction. When greater than 30 parts by weight, the chain-transfer agent remains unreacted and resultant copolymer has too little molecular weight, resulting in member contamination.

Resins included in an organic solvent are at least partially dissolved therein, and preferably have an acid value of from 2 to 26 mg KOH/g.

When higher than 26 mg KOH/g, the resin is likely to transfer into an aqueous phase, resulting in loss of material balance or deterioration of dispersion stability of an oil phase.

When less than 2 mg KOH/g, the resin has lower polarity and a colorant having a specific polarity is difficult to uniformly disperse in an oil drop.

The resins are not particularly limited, and a resin having a polyester skeleton is preferably used when included in a toner for developing electrostatic latent images because the resultant toner has good fixability.

The resin having a polyester skeleton include a polyester resin and a block polymer including a polyester resin and a resin having a different skeleton. The polyester resin is preferably used because the resultant colored resin particles have higher uniformity.

The polyester resin includes, but are not limited to, ring-opening polymeric lactones, condensation-polymeric hydroxycarboxylic acids, and polycondensed polyol and polycarboxylic acid. The polycondensed polyol and polycarboxylic acid is preferably used in terms of fixable design.

The polyester resin preferably has a molecular weight of from 1,000 to 30,000, more preferably from 1,500 to 10,000, and furthermore preferably from 2,000 to 8,000.

When less than 1,000, the resultant toner has poor heat resistant preservability. When greater than 30,000, the resultant toner has poor low-temperature fixability.

As the polyol (1), diol (1-1) and polyols having 3 valences or more (1-2) can be used, and (1-1) alone or a mixture of (1-1) and a small amount of (1-2) are preferably used.

Specific examples of diol (1-1) include alkylene glycols such as ethylene glycol, 1,2-propylene glycol, 1,3-propylene glycol, 1,4-butanediol, and 1,6-hexanediol; alkylene ether glycols such as diethylene glycol, triethylene glycol, dipropylene glycol, polyethylene glycol, polypropylene glycol and polytetramethylene ether glycol; alicyclic diols such as 1,4-cyclohexanedimethanol and hydrogenated bisphenol A; bisphenol such as bisphenol A, bisphenol F and bisphenol S; adducts of the above-mentioned alicyclic diol with an alkylene oxide such as ethylene oxide, propylene oxide and butylene oxide; and adducts of the above-mentioned bisphenol with an alkylene oxide such as ethylene oxide, propylene oxide and butylene oxide.

In particular, an alkylene glycol having 2 to 12 carbon atoms and adducts of bisphenol with an alkylene oxide are preferably used, and a mixture thereof is more preferably used.

Specific examples of the polyol having 3 valences or more (1-2) include multivalent aliphatic alcohols having 3 to 8 or more valences such as glycerin, trimethylolethane, trimethylolpropane, pentaerythritol and sorbitol; phenols having 3 or more valences such as trisphenol PA, phenolnovolak, cresolnovolak; and adducts of the above-mentioned polyphenol having 3 or more valences with an alkylene oxide.

As the polycarboxylic acid (2), dicarboxylic acids (2-1) and polycarboxylic acids having 3 or more valences (2-2) can be used. (2-1) alone, or a mixture of (2-1) and a small amount of (2-2) are preferably used.

Specific examples of the dicarboxylic acid (2-1) include alkylene dicarboxylic acids such as succinic acid, adipic acid and sebacic acid; alkenylene dicarboxylic acids such as maleic acid and fumaric acid; and aromatic dicarboxylic acids such as phthalic acid, isophthalic acid, terephthalic acid and naphthalene dicarboxylic acid.

In particular, an alkenylene dicarboxylic acid having 4 to 20 carbon atoms and an aromatic dicarboxylic acid having 8 to 20 carbon atoms are preferably used. Specific examples of the polycarboxylic acid having 3 or more valences (2-2) include aromatic polycarboxylic acids having 9 to 20 carbon atoms such as trimellitic acid and pyromellitic acid.

The polycarboxylic acid (2) can be formed from a reaction between one or more of the polyols (1) and an anhydride or lower alkyl ester of one or more of the above-mentioned acids. Suitable preferred lower alkyl esters include, but are not limited to, methyl esters, ethyl esters and isopropyl esters.

A modified resin having an isocyanate group at the end may be dissolved in an oil phase to prepare colored resin particles. The modified resin increases mechanical strength of the colored resin particles and prevents hot offset when fixed when used as a toner for developing electrostatic latent images.

The modified resin is obtained by a polymerization reaction with a monomer including isocyanate. Alternatively, after a resin having an active hydrogen at the end is polymerized, the resin is reacted with polyisocyanate to introduce an isocyanate group at the end of a polymer. The latter is preferably used because of controllability of introducing an isocyanate group.

Specific examples of the active hydrogen group include hydroxyl groups (alcoholic hydroxyl groups and phenolic hydroxyl groups), amino groups, carboxyl groups, and mercapto groups, but are not limited thereto. Among these, the alcoholic hydroxyl groups are preferably used.

The modified resin is preferably dissolved in an organic solvent in consideration of uniformity of particles, and preferably has a polyester skeleton.

Polyol and polycarboxylic acid are polycondensed while the number of functional groups of the polyol is larger than that of the polycarboxylic acid to prepare a polyester resin having an alcoholic hydroxyl group at the end.

A crystalline polyester resin may be used to improve low-temperature fixability of the colored resin particles. Having crystallinity, the crystalline polyester resin quickly decreases viscosity around an endothermic peak temperature. Namely, just before a melt starting temperature, the crystalline polyester resin has good thermostability, and quickly decreases viscosity (has sharp meltability) at the melt starting temperature and fixed. Therefore, the crystalline polyester resin forms a toner having both good thermostability and low-temperature fixability.

The crystalline polyester resin preferably includes a diol compound having 2 to 6 carbon atoms as an alcoholic component, particularly 1,4-butanediol, 1,6-hexanediol and their derivatives in an amount not less than 80% by mol, and more preferably from 85 to 100% by mol. Further, the crystalline polyester resin preferably includes a fumaric acid or a carboxylic acid having a double bond (C═C bond) and a structure having the following formula (1) synthesized with their derivatives as an acidic component.

[—O—CO—(CR1=CR2)l-CO—O—(CH₂)n]m (1)

wherein n and m are repeat units; 1 is an integer of from 1 to 3; and R1 and R2 independently represent s hydrogen atom or a hydrocarbon group.

The crystallinity and softening point of the crystalline polyester are controlled by the following method. Namely, polyol having 3 or more valences such as glycerin is added to the alcoholic component or polycarboxylic acid having 3 or more valences such as trimellitic acid anhydride is added to the acidic component, and subjected to condensation polymerization to form a non-linear polyester.

The molar structure of the crystalline polyester of the present invention can be identified by, not limited to, NMR measurement, X-ray diffraction, GC/MS, LC/MS, IR measurement. For example, in the infrared absorption spectrum, the crystalline polyester has an absorption based on δCH (outersurface deformation vibration) of olefin at 965±10 cm⁻¹ or 990±10 cm⁻¹.

As for the molecular weight of the polyester resin, when the molecular weight distribution is sharp and the molecular weight is low, the resultant toner has good low-temperature fixability. Therefore, the polyester resin preferably has a peak in a range of from 3.5 to 4.0 in an o-dichlorobenzene soluble GPC molecular-weight distribution in which the X-axis is log (M) and Y-axis is % by weight, and a peak half width not greater than 1.5, a weight-average molecular weight (Mw) of from 1,000 to 30,000, a number-average molecular weight (Mn) of from 500 to 6,000, and Mw/Mn of from 2 to 8.

The crystalline polyester preferably has a low melting point and a low 1/2 outflow temperature (F 1/2 temperature) as long as heat resistant preservability does not deteriorate, and preferably has a DSC endothermic peak temperature of from 50 to 150° C. When the melting point and the F 1/2 temperature are less than 50° C., the crystalline polyester deteriorates in heat resistant preservability and is likely to cause blocking in an image developer. When higher than 130° C., the crystalline polyester deteriorates in low-temperature fixability.

The crystalline polyester preferably has an acid value not less than 5 mg KOH/g, and more preferably not less than 10 mg KOH/g to have desired low-temperature fixability in terms of affinity between papers and the resin. Preferably not greater than 45 mg KOH/g to improve hot offset resistance. Further, a crystalline polymer preferably has a hydroxyl value of from 0 to 50 mg KOH/g, and more preferably from 5 to 50 mg KOH/g to have desired low-temperature fixability and good chargeability.

Known inorganic bases can be used to control a hydrogen concentration index in the process of preparing core particles.

Specific examples thereof include hydroxides such as lithium hydroxide, sodium hydroxide, potassium hydroxide, cesium hydroxide, magnesium hydroxide and calcium hydroxide; carbonates such as lithium carbonate, sodium carbonate, potassium carbonate, cesium carbonate, magnesium carbonate and calcium carbonate; hydrocarbonates such as lithium hydrocarbonate, sodium hydrocarbonate, potassium hydrocarbonate, cesium hydrocarbonate, magnesium hydrocarbonate and calcium hydrocarbonate; ammonium solutions and their mixtures.

The inorganic base needs mixing with an aqueous medium just before emulsified. When the inorganic base is mixed in an aqueous phase and retained, hydrolysis lowers pH, resulting in lowering of adherence efficiency of the resin particles B on the core particles. A large amount of the inorganic base is needed to prevent pH from lowering.

The organic solvent is preferably a volatile solvent having a boiling point less than 100° C. because the solvent can easily be removed afterwards.

Specific examples of such a solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These solvents can be used alone or in combination.

When the resin having a polyester skeleton is dissolved or a dispersed in an organic solvent, ester solvents such as methyl acetate, ethyl acetate and butyl acetate or ketone solvents such as methyl ethyl ketone and methyl isobutyl ketone are preferably used because of their solubility. Among these, methyl acetate, ethyl acetate and methyl ethyl ketone are more preferably used because of their solvent removability.

The aqueous medium includes water alone and mixtures of water with a solvent which can be mixed with water. Specific examples of the solvent include alcohols such as methanol, isopropanol and ethylene glycol; dimethylformamide; tetrahydrofuran; cellosolves such as methyl cellosolve; and lower ketones such as acetone and methyl ethyl ketone.

Surfactants are used to disperse an oil phase in an aqueous medium to form a droplet.

Specific examples thereof include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyl)glycin), and N-alkyl-N,N-dimethylammonium betaine.

A surfactant having a fluoroalkyl group can prepare a dispersion having good dispersibility even when a small amount of the surfactant is used. Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium-{omega-fluoroalkanoyl(C6-C8)-N-ethylamino}-1-propanesulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc. Specific examples of the cationic surfactants include primary, secondary and tertiary aliphatic amines having a fluoroalkyl group, aliphatic quaternary ammonium salts such as perfluoroalkyl(C6-C10)sulfoneamidepropyltrimethylammonium salts, benzalkonium salts, benzetonium chloride, pyridinium salts, imidazolinium salts, etc.

Next, resin particles A used as an emulsifier in the embodiment are explained.

Unlike the resin particles B added to impart chargeability and anti-stress effect after the core particles are formed, the resin particles A are added in an aqueous medium as an emulsifier to prevent oil drops from combining with each other and improve granularity.

Specific examples of the resin particles A in the aqueous medium include any thermoplastic and thermosetting resins capable of forming an aqueous dispersion, such as vinyl resins, a polyurethane resin, an epoxy resin, a polyester resin, a polyamide resin, a polyimide resin, silicon resins, a phenol resin, a melamine resin, a urea resin, an aniline resin, an ionomer resin and a polycarbonate resin. These resins can be used alone or in combination.

Among these resins, the vinyl resins, the polyurethane resin, the epoxy resin, the polyester resin and their combinations are preferably used in terms of forming an aqueous dispersion of microscopic spherical particulate resins.

Specific examples of the vinyl resins include polymers formed of homopolymerized or copolymerized vinyl monomers such as styrene-(meth)acrylic ester copolymers, styrene-butadiene copolymers, (meth)acrylic-acrylic ester polymers, styrene-acrylonitrile copolymers, styrene-maleic anhydride polymers and styrene-(meth)acrylic copolymers. The resin particles A have an average particle diameter of from 35 to 55 nm.

Dispersed droplets may be dispersed with a polymeric protection colloid.

Specific examples of the protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

When an acid such as calcium phosphate or a material soluble in alkaline is used as a dispersant, the calcium phosphate is dissolved with an acid such as a hydrochloric acid and washed with water to remove the calcium phosphate from a toner. Besides this method, it can also be removed by an enzymatic hydrolysis. When a dispersant is used, the dispersant may remain on the surface of a toner, but is preferably washed to remove in terms of the chargeability thereof.

Specific examples of colorants for use in the embodiment include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake. Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and their mixtures.

Masterbatches, which are complexes of a colorant with a resin (binder resin), can be used as the colorant of the toner.

Specific examples of the resin for use in the masterbatches include polyesters; styrene homopolymers and substituted styrene homopolymers such as polystyrene, poly-p-chlorostyrene, and polyvinyl toluene; copolymers of styrene (and substituted styrene) such styrene-p-chlorostyrene copolymers, styrene-propylene copolymers, styrene-vinyl toluene copolymers, styrene-vinyl naphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, and styrene-maleate copolymers; methacrylic homopolymers such as polymethyl methacrylate, and polybutyl methacrylate; vinyl homopolymers such as polyvinyl chloride, polyvinyl acetate, polyethylene, and polypropylene; and other resins such as epoxy resins, epoxy polyol resins, polyurethane resins, polyamide resins, polyvinyl butyral resins, polyacrylic acid, rosin, modified rosins, terpene resins, aliphatic or alicyclic hydrocarbon resins, aromatic petroleum resins, chlorinated paraffin, and paraffin waxes. These resins can be used alone or in combination.

Such masterbatches can be prepared by mixing a resin and a colorant, and kneading the mixture while applying a high shearing force thereto. In this case, an organic solvent can be added to enhance the interaction between the colorant and the resin.

In addition, it is preferable to use a flushing method, in which an aqueous paste including a colorant and water is mixed with a resin dissolved in an organic solvent, the mixture is kneaded to transfer the colorant from the aqueous phase to the resin side (i.e., the oil phase), and then the organic solvent (and water, if desired) is removed from the kneaded mixture, because the resultant wet cake can be used without being dried.

When performing the mixing and kneading process, dispersing devices capable of applying a high shearing force such as three roll mills can be preferably used. A hydrosoluble polymer may be added to further stabilize the dispersed droplet.

Specific examples of the hydrosoluble polymers include, but are not limited to, cellulose compounds such as methyl cellulose, ethyl cellulose, hydroxy ethyl cellulose, ethyl hydroxy ethyl cellulose, carboxy methyl cellulose, hydroxy propyl cellulose and their saponified products; gelatin; starch; dextrin; acacia; chitin; chitosan; polyvinylalcohol; polyvinylpyrrolidone; polyethyleneglycol; polyethylene imine; polyacrylamide; polymers including acrylic acid (salt) such as sodium polyacrylate, potassium polyacrylate, ammonium polyacrylate, polyacrylic acid partially-neutralized with sodium hydroxide and sodium acrylate-ester acrylate copolymers; styrene-maleic anhydride (partially-)neutralized with sodium hydroxide; and hydrosoluble polyurethanes such as reaction products between polyethylene glycol or polycaprolactone and polyisocyanate.

When the colored resin particles are used as a toner for developing electrostatic latent images, a release agent may be dispersed in the organic solvent for the purpose if increasing releasability.

As the release agent, materials such as waxes and silicone oils having sufficiently low viscosity when heated in the fixing process and difficult to be compatible or swell with other materials are used. In consideration of preservation stability of the colored resin particles, a wax present in the colored resin particles as a solid when stored is preferably used.

The wax includes long-chain hydrocarbons and waxes having a carbonyl group. Specific examples of the long-chain hydrocarbons include polyolefin waxes such as polyethylene waxes and polypropylene waxes; petroleum waxes such as paraffin waxes, SAZOL waxes and microcrystalline waxes; and Fischer Tropsch waxes.

Specific examples of the waxes having a carbonyl group include esters of polyalkanoic acids (such as carnauba waxes, montan waxes, trimethylolpropane tribehenate, pentaerythritol tetrabehenate, pentaerythritol diacetate dibehenate, glycerin tribehenate, and 1,18-octadecanediol distearate); polyalkanol esters (such as tristearyl trimellitate, and distearyl maleate); polyalkanoic acid amides (such as ethylenediamine dibehenyl amide); polyalkylamides (such as trimellitic acid tristearylamide); and dialkyl ketones (such as distearyl ketone).

Particularly, the long-chain hydrocarbons having good releasability are preferably used. Further, when they may be combined with the waxes having a carbonyl group.

Further, a charge controlling agent may be dissolved or dispersed in the organic solvent when necessary.

Any known charge controlling agents can be used. Specific examples thereof include Nigrosine dyes, triphenyl methane dyes, chromium-containing metal complex dyes, molybdic acid chelate pigments, Rhodamine dyes, alkoxyamines, quaternary ammonium salts, alkylamides, phosphor and its compounds, tungsten and its compounds, fluorine-containing surfactants, metal salts of salicylic acid, metal salts of salicylic acid derivatives, copper phthalocyanine, perylene, quinacridone, azo pigments, polymers having a functional group such as a sulfonate group, a carboxyl group, and a quaternary ammonium salt group.

Specific examples of marketed charge controlling agents include BONTRON 03 (Nigrosine dye), BONTRON P-51 (quaternary ammonium salt), BONTRON S-34 (metal-containing azo dye), BONTRON E-82 (metal complex of oxynaphthoic acid), BONTRON E-84 (metal complex of salicylic acid), and BONTRON E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and COPY CHARGE NX VP434 (quaternary ammonium salt), which are manufactured by Hoechst AG; LRA-901 and LR-147 (boron complex), which are manufactured by Japan Carlit Co., Ltd.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### <Preparation of Dispersion of Resin Particles A>

The following materials were placed in a reaction vessel including a stirrer and a thermometer.

| | |
|---|---|
| Water | 683 |
| Sodium salt of an adduct of a sulfuric ester | 11 |
| with ethyleneoxide methacrylate | |
| (ELEMINOL RS-30 from Sanyo Chemical Industries, Ltd.) | |
| Sodium salt of an adduct of a sulfuric ester | 5 |
| with ethyleneoxide dodecanol | |
| (CALIPON EN-200 from Sanyo Chemical Industries, Ltd.) | |
| Styrene | 83 |
| Methacrylate | 83 |
| Butyl acrylate | 110 |
| Persulfate ammonium | 1 |

These were stirred for 15 min at 500 rpm to prepare a white emulsion therein.

The white emulsion was heated to have a temperature of 75° C. and reacted for 2 hrs. Further, 30 parts of an aqueous solution of persulfate ammonium having a concentration of 1% were added thereto and the mixture was left for 8 hrs at 75° C. to prepare a dispersion of resin particles A including a solid content of a vinyl resin (a copolymer of a sodium salt of an adduct of styrene-methacrylate-butylacrylate-sulfuric ester with ethyleneoxide methacrylate) by 20%. The dispersion of resin particles A had a volume-average particle diameter of 38 nm.

### <Preparation of Dispersion of Resin Particles B>

In a reactor vessel including a cooling pipe, a stirrer and a nitrogen inlet pipe, 0.7 parts of dodecyl sodium sulfate and 498 parts of ion-exchanged water were heated to have a temperature of 80° C. while stirred to be dissolved. Then, a solution including 2.6 parts of potassium persulfate and 104 parts of ion-exchanged water was added. Fifteen (15) minutes later, a monomer mixed liquid including 200 parts of styrene monomer and 4.2 parts of n-octanethiol was dropped in for 90 min. Then, a polymerization reaction was performed for 60 min at 80° C. Then, the polymerized mixture was cooled to prepare a white dispersion of resin particles B having a volume-average particle diameter of 105 nm.

### <Synthesis of Low-Molecular-Weight Polyester>

The following materials were placed in a reactor vessel including a cooling pipe, a stirrer and a nitrogen inlet pipe and reacted for 8 hrs at a normal pressure and 230° C.

| | |
|---|---|
| Adduct of bisphenol A with 2 moles of ethyleneoxide | 220 |
| Adduct of bisphenol A with 3 moles of propyleneoxide | 561 |
| Terephthalic acid | 218 |
| Adipic acid | 48 |
| Dibutyltinoxide | 2 |

Further, after the mixture was depressurized by 10 to 15 mm Hg and reacted for 5 hrs, 45 parts of trimellitic acid anhydride were added thereto and the mixture was reacted for 2 hrs at a normal pressure and 180° C. to prepare a [low-molecular-weight polyester 1] having a number-average molecular weight of 2,500, a weight-average molecular weight of 6,700, a Tg of 43° C. and an acid value of 25 mg KOH/g.

### <Synthesis of Crystalline Polyester>

The following materials were placed in a reactor vessel including a cooling pipe, a stirrer and a nitrogen inlet pipe and reacted at 160° C. for 5 hrs.

| | |
|---|---|
| 1,4-butanediol | 2,070 |
| Fumaric acid | 2,535 |
| Trimellitic acid anhydride | 291 |
| Hydroquinone | 4.9 |

These were further reacted at 200° C. for 1 hr. and further at 8.3 KPa for 1 hr to prepare a crystalline polyester.

### <Preparation of Crystalline Polyester Dispersion>

Thirty-six (36) parts of the crystalline polyester were mixed in ethyl acetate and dissolved at 55° C. for 1 hr. Then, the solution was cooled to have a temperature not higher than 20° C. by an outer heat exchanger using coolant water to precipitate the crystalline polyester and prepare a crystallization liquid.

The crystalline polyester crystallization liquid was subjected to circulation pulverization in a beads mill (LMZ25 from Ashizawa Finetech Ltd.) using zirconia beads having a diameter of 0.5 mm to prepare a crystalline polyester dispersion.

### <Preparation of Release Agent Crystallization Liquid>

Twelve point two (12.2) % by weight of ester wax (LW-13 from Sanyo Chemical Industries, Ltd.), 8.5% by weight of a dispersant (styreneacryl from Sanyo Chemical Industries, Ltd.) and 36.6% by weight of the low-molecular-weight polyester were added in 77.1% by weight of ethyl acetate, and heated at 60° C. for 3 hrs to be melted. Then, the solution was cooled by an outer heat exchanger to have a temperature not higher than 30° C. to prepare a release agent crystallization liquid.

### <Preparation of Release Agent Dispersion>

The release agent crystallization liquid was subjected to circulation pulverization in a beads mill (LMZ60 from Ashizawa Finetech Ltd.) using zirconia beads having a diameter of 0.3 mm to prepare a release agent dispersion.

### <Preparation of Low-Molecular-Weight Polyester Solution>

Seventy (70) % by weight of the low-molecular-weight polyester resin were dissolved in ethylacetate at 40° C. to prepare a low-molecular-weight polyester solution.

### Example 1

### Preparation of Oil Phase

Two fifteen (215) parts of the release agent dispersion, 431 parts of the low-molecular-weight polyester solution, 43 parts of a black pigment C-60 and 57 parts the low-molecular-weight polyester were kneaded to prepare a masterbatch. Ninety-one (91) parts of the masterbatch, 153 parts of ethyl acetate and 106 parts of methyl acetate were dissolved and dispersed in a tank for 3 hrs. Next, the dispersion was dispersed for 6 hrs by a high-efficiency disperser (Ebara Milder from Ebara Corp.) to prepare an oil phase 1.

### <Synthesis of Prepolymer>

Seven ninety-five (795) parts of an adduct of bisphenol A with 2 moles of ethyleneoxide, 200 parts of isophthalic acid, 65 parts of terephihalic acid and 2 parts of dibutyltinoxide were mixed and subjected to condensation reaction in a reactor vessel including a cooling pipe, a stirrer and a nitrogen inlet pipe for 8 hrs at a normal pressure and 210° C. under a nitrogen stream.

Next, the mixture was dehydrated under reduced pressure of from 10 to 15 mm Hg and reacted for 5 hrs. Then, the mixture was cooled to have a temperature of 80° C. and reacted with 170 parts of isophoronediisocyanate in ethyl acetate for 2 hrs to prepare a prepolymer 1.

The prepolymer had a weight-average molecular weight of 5,000.

### <Preparation of Aqueous Phase)

1,180 parts of water, 51 parts of the dispersion of resin particles A, 262 parts of an aqueous solution of sodium dodecyldiphenyletherdisulfonate having a concentration of 50% (ELEMINOL MON-7 from Sanyo Chemical Industries, Ltd.) and 138 parts of ethyl acetate were mixed and stirred to prepare an aqueous phase 1

### <Emulsification>

The following materials were mixed in a pipe line homomixer from PRIMIX Corp. at 2,960 rpm for 60 min to prepare a dispersion of colored resin particles.

| | |
|---|---|
| Oil phase 1 | 4.20 kg/min |
| Prepolymer 1 | 0.84 kg/min |
| Aqueous phase 1 | 8.39 kg/min |
| Sodium hydroxide | 0.634 kg/min |
| having a concentration of 4% | |
| ethyl acetate | 0.42 kg/min |

### <Transfer of Resin Particles B>

The dispersion of colored resin particles was fed into the junction pipe 20 having an inner diameter of 43 mm at 14.48 kg/min in FIG. 2. A mixture of 30 parts of the dispersion of resin particles B and 45 parts of water was added thereto at 1.448 kg/min. A mixed liquid of the dispersion of colored resin particles and the dispersion of resin particles B was mixed by the fluid stirrer 10 to prepare a dispersion of complex particles. One fifty-one (151) parts (100% by weight relative to a weight of the core particles) of pure water were added to the dispersion of complex particles.

The blade member 2 of the fluid stirrer 10 had a twist angle of one unit of 180°, a pitch relative to the pipe diameter (P/D) of 1.5, and the pipe thereof had an inner diameter of 43 mm. As a baffle plate, a square bar having a size of 4 mm×6 mm was linearly located in an axial direction, 4 square bars were located at equal intervals in a circumferential direction, and a ratio (H/D) of a height (H) of the baffle plate to the axial center direction relative to the pipe diameter (D) was 0.14. Element had no holes. The number thereof was 6. Static mixer had a length of 150 m.

A mixed liquid obtained by the fluid stirrer 10 was sequentially subjected a de-solvent process, a washing and drying process and an external additive application process to prepare a black toner (1).

### Example 2

The procedure for preparation of black toner (1) in Example 1 was repeated except that the flow channel limiting plate 5 of the fluid stirrer 10 has an outer diameter which is an inner diameter of the flow channel pipe 1 and one ring-shaped member having an inner diameter which is an outer diameter of the spiral blade member 2 is located in each element in the resin particles B transfer process to prepare a black toner (2).

### Example 3

The procedure for preparation of black toner (2) in Example 2 was repeated except that four holes having a diameter of 4 mm were formed on each element of the spiral blade member 2 of the fluid stirrer 10 in the resin particles B transfer process to prepare a black toner (3).

### Example 4

The procedure for preparation of black toner (1) in Example 1 was repeated except that the blade member 2 of the fluid stirrer 10 had a twist angle of one unit of 90°, a pitch relative to the pipe diameter (P/D) of 1.5, and the pipe thereof had an inner diameter of 37.1 mm, as a baffle plate, a square bar having a size of 3 mm×3 mm was linearly located in an axial direction, 4 square bars were located at equal intervals in a circumferential direction, and a ratio (H/D) of a height (H) of the baffle plate to the axial center direction relative to the pipe diameter (D) was 0.09, element had no holes, and the number thereof was 12 to prepare a black toner (4).

### Example 5

The procedure for preparation of black toner (4) in Example 4 was repeated except that the flow channel limiting plate 5 of the fluid stirrer 10 has an outer diameter which is an inner diameter of the flow channel pipe 1 and one ring-shaped member having an inner diameter which is an outer diameter of the spiral blade member 2 is located in each element in the resin particles B transfer process to prepare a black toner (5).

### Example 6

The procedure for preparation of black toner (5) in Example 5 was repeated except that two holes having a diameter of 4 mm were formed on each element of the spiral blade member 2 of the fluid stirrer 10 in the resin particles B transfer process to prepare a black toner (6).

The measurement results of Examples 1 to 6 are shown in Tables 1-1 to 1-3.

TABLE 1-1

| | | | | | | Flow |
|---|---|---|---|---|---|---|
| | | | | | | Channel |
| | Twist | | Pipe | Baffle | | Limiting |
| | Angle | Pitch P/D | Diameter | Plate | H/D | Plate |
| Example 1 | 180° | 1.5 | 43.0 mm | Yes | 0.14 | No |
| Example 2 | 180° | 1.5 | 43.0 mm | Yes | 0.14 | Yes |
| Example 3 | 180° | 1.5 | 43.0 mm | Yes | 0.14 | Yes |
| Example 4 | 90° | 1.0 | 37.1 mm | Yes | 0.08 | No |
| Example 5 | 90° | 1.0 | 37.1 mm | Yes | 0.08 | Yes |
| Example 6 | 90° | 1.0 | 37.1 mm | Yes | 0.08 | Yes |

TABLE 1-2

| | | | | b | |
|---|---|---|---|---|---|
| | | | | | Unevenness |
| | | | | Resin | of Resin |
| | | a | | Particles B | Particles B |
| | | | Coarse | Adherence | Adherence |
| | Hole | ΔDv | Particles | Rate | Rate |
| Example 1 | No | Good | A | Good | Good |
| Example 2 | No | Good | A | Good | Excellent |
| Example 3 | Yes | Good | S | Good | Excellent |
| Example 4 | No | Good | A | Good | Excellent |
| Example 5 | No | Excellent | S | Good | Excellent |
| Example 6 | Yes | Excellent | S | Excellent | Excellent |

TABLE 1-3

| | c | | d | | |
|---|---|---|---|---|---|
| | | Unevenness | Photo- | e | f |
| | Resin | of Resin | receptor | Fixable | Heat |
| | Particles B | Particles B | back- | Minimum | Resistant |
| | Adherence | Adherence | ground | Temper- | Preserv- |
| | Strength | Strength | fouling | ature | ability |
| Example 1 | Good | Good | Good | Good | Good |
| Example 2 | Good | Excellent | Good | Good | Good |
| Example 3 | Good | Excellent | Good | Good | Good |
| Example 4 | Good | Excellent | Good | Good | Good |
| Example 5 | Good | Excellent | Good | Good | Good |
| Example 6 | Excellent | Excellent | Good | Good | Good |

Pitch is a non-dimensional ratio of a pitch of the blade member 2 to an inner diameter of the flow channel pipe.

ΔDv (Toner volume particle variation) and Coarse Particles were measured by coulter Counter TA-II from Coulter Electronics, Inc. having an aperture diameter of 100 μm.

### <Toner Volume Particle Variation (ΔDv)>

The toner volume particle variation was determined as follows.

In the emulsification process, the volume particle central value of the emulsified dispersion just after sheared by an emulsifier was Dv1. In the resin particles B transfer process, 600 sec were passed after starting transferring the resin particles B. Then, the volume particle central value of the emulsified dispersion was Dv2, ΔDv=Dv2−Dv1. An average of ten-time measurement was determined.

When the toner volume particle variation is large, toner particles become large and it is difficult to control toner particles. Therefore. ΔDv is preferably less than 0.5 μm, more preferably less than 0.2 μm, and furthermore preferably less than 0.1 μm.

Evaluation standard of the toner volume particle variation (ΔDv) is as follows.

Excellent: less than 0.1 μm

Good: not less than 0.1 μm and less than 0.2 μm

Fair: not less than 0.2 μm and less than 0.5 μm

Poor: not less than 0.5 μm

### <Coarse Particles>

The coarse particles included in a toner have a particle diameter of from 12.7 to 40.4 μm. This was evaluated by % by volume. An average of ten-time measurement was determined. The larger the coarse particles, the less the productivity and the yield rate. Therefore, the coarse particles are preferably less than 12%, more preferably less than 5%, and furthermore preferably less than 2%.

Evaluation standard of the toner coarse particles is as follows.

Excellent: less than 1%

Good: not less than 1% and less than 2%

Average: not less than 2% and less than 5%

Fair: not less than 5% and less than 12%

Poor: not less than 12%

### <Resin Particles B Adherence Rate>

Adherence of the resin particles B to the core particles was measured by a spectral densitometer X-Rite 939 from X-Rite, Inc. Specifically, spectra of resin particles B solutions were measured by a spectral densitometer X-Rite 939 and a calibration curve deriving a concentration of the resin particles B was formed from the resultant spectra. Next, 1.6 mL of the dispersion of the resin particles B after transferred were diluted in 11 mL of pure water. The diluted dispersion was subjected to centrifugal separation to obtain a supernatant liquid. The liquid was placed in an optical cell and a spectrum thereof was measured by X-Rite 939. From the calibration curve, an amount Q1 of the residual resin particles B which do not adhere to the core particles was determined. When a total amount of the resin particles B is Q0, the adherence rate (R) of the resin particles B is determined by the following formula:

R=(Q0−Q1)/Q0

An average of ten-time measurement was determined.

When the adherence rate (R) of the resin particles B is low, the resultant toner is not sufficiently charged, which causes production of abnormal images such as background fouling. Further, the residual resin particles B cause clogging of a filter in the washing process, which causes deterioration of washing efficiency. Therefore, the adherence rate (R) of the resin particles B is preferably not less than 95%, more preferably not less than 98%, and furthermore preferably not less than 99%.

Evaluation standard of the adherence rate (R) of the resin particles B is as follows.

Excellent: not less than 99%

Good: not less than 98% and less than 99%

Fair: not less than 95% and less than 98%

Poor: less than 95%

The average of ten-time measurement was Q2, the adherence rate for the N time was R_{N}, and unevenness S between the average of ten-time measurement and each time was determined by the following formula:

S=(Σ|Q2−R_{N}|)/10

The larger the unevenness, the less the productivity and the yield rate. Therefore, the unevenness S is preferably less than 2%, more preferably less than 1.5%, and furthermore preferably less than 1%.

Evaluation standard of the unevenness of the adherence rate (R) of the resin particles B is as follows.

Excellent: less than 1%

Good: not less than 1% and less than 1.5%

Fair: not less than 1.5% and less than 2%

Poor: not less than 2%

### <Resin Particles B Adherence Strength>

Adherence strength of the resin particles B to the core particles was measured by the following method.

An aqueous solution of sodium dodecyl sulfate having a concentration of 5% and 4 g of mother toner particles were placed in a glass container having a capacity of 110 ml, and stirred for 60 min. The solution was placed in a stainless cup having a capacity of 200 ml. An ultrasonic energy was applied to the stainless cup by an ultrasonic homogenizer SONICS-VCX750 from Sonics & Materials, Inc. at 80 W for 5 min while cooled with iced water. Then, the solution was subjected to centrifugal separation by a centrifugal separator CN-1040 from Matsuuraseisakusyo, Ltd. at 3,000 rpm for 5 min. A transmittance at 800 nm when the resultant supernatant liquid was measured by an UV-visible spectrometer UV-2550 from Shimadzu Corp. was the adherence strength of the resin particles B.

The larger the adherence strength of the resin particles B, the less the resin particles B release. Therefore, the adherence strength thereof is preferably not less than 60, more preferably not less than 70 and furthermore preferably not less than 80.

Evaluation standard of the adherence strength of the resin particles B is as follows.

Excellent: not less than 80

Good: not less than 70 and less than 80

Fair: not less than 60 and less than 70

Poor: less than 60

The average of ten-time measurement was T0, the adherence strength for the N time was T_{N}, and unevenness U between the average of ten-time measurement and each time was determined by the following formula:

U=(Σ|T0−T_{N}|)/10

The larger the unevenness, the less the productivity and the yield rate. Therefore, the unevenness U is preferably less than 8%, more preferably less than 5%, and furthermore preferably less than 3%.

Evaluation standard of the unevenness of the adherence strength of the resin particles B is as follows.

Excellent: less than 3%

Good: not less than 3% and less than 5%

Fair: not less than 5% and less than 8%

Poor: not less than 8%

### <Photoreceptor Background Fouling>

The toner prepared in each Example was provided in ipsio SPC220. Before and after 2,000 images of a predetermined print pattern having a printed area of 6% were produced at 23° C. and 45% Rh, background fouling L* was determined a by a tape transfer method. Namely, a toner remaining on a photoreceptor is transferred onto a mending tape from Sumitomo 3M Ltd. The mending tape and a tape before a toner was transferred onto were applied on blank papers. The reflected densities thereof were measured by X-Rite 939 and a difference was the background fouling L*.

Evaluation standard of the photoreceptor background fouling is as follows.

Good: L* is less than 2%

Fair: L* is not less than 2% and less than 5%

Poor: L* is not less than 5%

Good and Fair were usable.

### <Fixable Minimum Temperature>

Images were produced by a modified ipsio SP 0220 from Ricoh Company, Ltd. on TYPE 6200 papers. Specifically, the fixing temperature was changed to determine cold offset temperature (fixable minimum temperature).

The papers were fed at a linear speed of from 120 to 150 mm/sec, a surface pressure of 1.2 kgf/cm², and a nip width of 3 mm in determining the fixable minimum temperature.

The papers were fed at a linear speed of 50 min/sec, a surface pressure of 2.0 kgf/cm², and a nip width of 4.5 min in determining the fixable maximum temperature.

Evaluation standard of the fixable minimum temperature is as follows.

Good: less than 130° C.

Fair: not less than 130° C. and less than 140° C.

Poor: not less than 140° C.

Good and Fair were usable.

### <Heat-Resistant Preservability>

A 50-ml glass vial was filled with each toner and left in a constant-temperature chamber at 50° C. for 24 hours, followed by cooling to 24° C. The toner is then subjected to a penetration test based on JIS K-2235-1991. Penetration (mm) represents how deep the needle penetrates the above toner in the vial. The heat-resistant preservability was evaluated by the following standard. The greater the penetration, the better the heat-resistant preservability.

Good: not less than 25 mm

Fair: not less than 15 mm and less than 25 mm

Poor: less than 15 mm

Good and Fair were usable.

### Modified Example

In the resin particles B transfer process of the embodiment, the dispersion of resin particles B was placed in the dispersion of core particles prepared in the emulsification process (dispersion of core particles process) while fed in the pipe to transfer the resin particles B onto the core particles. Thus, unevenness of the toner particle diameter, adherence rate and strength of the resin particles B can be prevented more than the resin particles B transfer process of the conventional toner preparation method in which the dispersion of resin particles B is fed in a stirring container filled with a predetermined amount of the dispersion of core particles.

Hereinafter, as a modified example, a toner preparation method in which the dispersion of resin particles B was placed in the dispersion of core particles prepared in the emulsification process while fed in the pipe to transfer the resin particles B onto the core particles is explained.

FIG. 10 is a schematic view illustrating an embodiment of the mixer 100 used in toner preparation method of Modified Example.

An oil phase including an organic solvent and at least a resin, a release agent and a colorant dissolved or dispersed therein is in an oil phase tank T1. The oil phase tank T1 includes an oil phase tank liquid surface meter S4 monitoring an amount of the oil phase therein. The oil phase tank T1 forms a feed line to a disperser M1 with a pipe through an oil phase tank bottom valve V1. The oil phase is fed to the disperser M1 by an oil phase feed pump P1 and a flow speed thereof is monitored by an oil phase flow amount meter S1.

An aqueous solvent is in an aqueous solvent tank T2. The aqueous solvent tank T2 includes an aqueous solvent tank liquid surface meter S5 monitoring an amount of the aqueous solvent therein. The aqueous solvent tank T2 forms a feed line to a disperser M1 with a pipe through an aqueous solvent tank bottom valve V2. The aqueous solvent is fed to the disperser M1 by an aqueous solvent feed pump P2 and a flow speed thereof is monitored by an aqueous solvent flow amount meter S2.

The resin particles A are mixed in the aqueous solvent. In the disperser M1, the oil phase and the aqueous solvent are applied with a shearing force to produce a dispersion of core particles including the aqueous solvent and the oil phase dispersed therein.

A line circulating to the disperser M1 and a line to a mixing element M2 therefrom are formed with pipes. The dispersion of core particles produced in the disperser M1 is partially discharged to the mixing element M2 and the rest circulates a circulation route and reaches the disperser M1, and is further applied with a shearing force. The oil phase and the aqueous solvent are fed from the oil phase tank T1 and the aqueous solvent tank T2, respectively to the circulation route to be discharged to the mixing element M2 when overflowed.

The resin particles B or the dispersion of resin particles B is in a resin particles B tank T3. The resin particles B tank T3 includes a resin particles tank liquid surface meter S6 monitoring an amount of the resin particles B or the dispersion of resin particles B. The resin particles B tank T3 forms a feed line to the mixing element M2 with a pipe through a resin particles tank bottom valve V3. The resin particles B or the dispersion of resin particles B is fed to the mixing element M2 by a resin particles B feed pump P3 and a feed amount thereof is monitored by a resin particles B flow amount meter S3.

The mixing element M2 mixes the dispersion of core particles produced by the disperser M1 and the resin particles B. The mixing element M2 forms a line to a mixed dispersion tank T4 or a waste liquid tank T5 with a pipe after mixing.

A switch valve V4 switches feeding liquid to the mixed dispersion tank T4 and the waste liquid tank T5 at a branch in the line thereto after mixing from the mixing element M2. The mixed dispersion before quality thereof is stabilized is fed to the waste liquid tank T5. The waste liquid tank T5 includes a waste liquid tank liquid surface meter S8 monitoring an amount of the waste liquid therein. The mixed dispersion after quality thereof is stabilized is fed to the mixed dispersion tank T4. The mixed dispersion tank T4 includes a mixed dispersion tank liquid surface meter S7 monitoring an amount of the mixed dispersion therein.

Ball valves can be used for the oil phase tank bottom valve V1, the aqueous solvent tank bottom valve V2 and the resin particles tank bottom valve V3, and [symbol] formed ball valve can be used for the switch valve V4.

A rotary pump can be used for the oil phase feed pump P1 and a diaphragm pump can be sued for the aqueous solvent feed pump P2 and the resin particles B feed pump P3. A mass flow amount meter can be used for the oil phase flow amount meter S1, the aqueous solvent flow amount meter S2 and the resin particles B flow amount meter S3. A diaphragm-type differential pressure transmittor can be sued for the oil phase tank liquid surface meter S4, the aqueous solvent tank liquid surface meter S5, the resin particles tank liquid surface meter S6, the mixed dispersion tank liquid surface meter S7 and the waste liquid tank liquid surface meter S8.

Specific examples of the disperser M1 include, but are not limited to, known dispersers such as low-speed shearing dispersers, high-speed shearing dispersers, friction dispersers, high-pressure jet dispersers and ultrasonic dispersers. The high-speed shearing dispersers are preferably used to prepare dispersed materials having a particle diameter of from 2 to 20 μm. The high-speed shearing dispersers preferably rotate at from 1,000 to 30,000 rpm, and more preferably from 5,000 to 15,000 rpm. A pipeline homomixer 2W6 from PRIMIX Corp. can be sued for the disperser M1.

The mixing element M2 is not particularly limited, and includes a passage pipe a fluid passes inside and plural fluid passages on the inside of the passage pipe. A static mixer from Noritake Co., Ltd. can be used as the mixing element M2. It is more preferable to use the fluid stirrer 10 to promote mixing further.

The mixer 100 in Modified Example includes a core particles dispersion process of dispersing an oil phase including an organic solvent and at least a resin, a release agent and a colorant dissolved or dispersed therein in the aqueous solvent including the resin particles A in the disperser M1. Thus, a dispersion of core particles including dispersed core particles formed of an oil phase as a main component is formed. Next, while the dispersion of core particles having passed the disperser M1 moves to the mixing element 2, fine particles formed of an oil phase as a main component in the aqueous solvent converge to form core particles having a size. Therefore, a process in which the dispersion of core particles moves from the disperser M1 to the mixing element 2 is a convergence process.

Next, the resin particles B transfer process of adding the resin particles B or the dispersion of resin particles B to the dispersion of core particles prepared in the convergence process to transfer the resin particles B to the surfaces of the core particles is performed.

The mixer 100 in Modified Example adds the resin particles B or the dispersion of resin particles B while the dispersion of core particles is fed to be mixed in the pipe and transfer the resin particles B to the core particles. Thus, the resin particles B or the dispersion of resin particles B can quickly and uniformly be mixed with the dispersion of core particles converged for the same short time to prevent unevenness of particle diameter, and adherence rate and strength of the resin particles B to the core particles.

The mixer 100 in Modified Example locates the mixing element M2 as a fluid stirrer at a pipe after the resin particles B or the dispersion of resin particles B is added to the dispersion of core particles. Namely, the mixing element M2 is located as a means of transferring the resin particles B to the surfaces of the core particles. Thus, mixture of the resin particles B and the dispersion of core particles is promoted to prevent unevenness of particle diameter, and adherence rate and strength of the resin particles B to the core particles.

Conventional toner preparation methods are explained.

The toner preparation method in Modified Example relates to a method of preparing colored toner particles, on the surface of which resin particles adhere, usable as a toner for developing electrostatic latent images in electrophotography. In electrophotographic image forming apparatus, colored resin particles including a colorant is used as a toner to form a visible image. Among various toners, a polymerization toner has a small particle diameter and a narrow particle diameter distribution.

When a binder resin including polyester resin having good fixability as a main component is used, at least a binder resin such as a polyester resin and a colorant are dissolved or dispersed in an organic solvent to prepare an oil phase. Next, the oil phase is dispersed in an aqueous phase including at least a surfactant to prepare a dispersion, the organic solvent is removed therefrom to obtain resin particles, and the resin particles are washed and dried to prepare a toner (solution suspension method). However, a toner including a polyester resin as a main component of the binder resin tends to be more difficult to charge than a toner including a styrene acrylic resin as a main component.

Particularly in a one-component developing system, a toner is charged by stirring or friction by or between feed members such as feed rollers and developer bearers such as developing rollers, or friction between the developer bearers and a regulation blade. In the one-component developing system, a toner has less opportunity to be charged than a two-component developing system mixing a toner with a carrier such as iron powder to be charged. Therefore, a toner having low chargeability is a large problem. As one of methods to solve this problem, a method of placing a vinyl resin having good chargeability on the surface of a toner is known.

For example, after an oil phase is dispersed in an aqueous phase to form an oil drop, a method of placing a dispersion of vinyl resin particles in the oil drop dispersion before an organic solvent is removed therefrom is known. The dispersion of vinyl resin particles is obtained by polymerizing an aromatic compound having a vinyl polymerizable functional group and 0 to 7% by weight of a mixture of monomers having a vinyl polymerizable functional group and an acidic group.

Resin particles do not adhere well to the surfaces of core particles of a toner prepared by this method. The toner does not improve in chargeability satisfactory as a toner. In order to improve adherence of the resin particles, after an oil phase is dispersed in an aqueous phase to form an oil drop, a method of heating the oil drop dispersion under reduced pressure and mixing vinyl resin particles therewith after adjusting a concentration of an organic solvent in an aqueous medium the core particles are dispersed in to be 0.10 to 5.00% by weight is known.

However, this method needs much time to transfer resin particles, which deteriorates productivity. In addition, the oil drop dispersion needs heating at 70° C. or more to fix the vinyl resin on the core particles, which deteriorates the resin and low-temperature fixability of the toner. Further, a large amount of energy is needed to industrially produce the toner, which is economically and environmentally disadvantageous.

Methods of efficiently transferring resin particles onto the core particles without heating at high temperature to prepare colored resin particles having low-temperature fixability and stable chargeability as a toner for developing electrostatic latent images include the following method. Namely, a core particles dispersion process of dispersing an oil phase including an organic solvent and at least a resin, a release agent and a colorant dissolved or dispersed therein in the aqueous solvent including the resin particles to form a dispersion of core particles including dispersed core particles formed of an oil phase as a main component is performed. Next, a convergence process converging the core particles in the dispersion is performed, and a resin particles B transfer process of adding the resin particles B or the dispersion of resin particles B to the dispersion of core particles prepared in the convergence process to transfer the resin particles B to the surfaces of the core particles is performed. The core particles dispersion process, the convergence process and the resin particles B transfer process are included, and the resin particles B transfer process places the dispersion of core particles in a tank and adds the resin particles B or the dispersion of resin particles B thereto to be mixed in the tank. This is a batch method, in which the resin particles B adhere to the core particles in the tank.

Since the resin particles B or the dispersion of resin particles B is added to the dispersion of core particles after placed in the tank, the resin particles B or the dispersion of resin particles B is added to the core particles having different convergence time. The core particles having long convergence time become coarse. The core particles varies in convergence time, and further the resin particles B or the dispersion of resin particles B takes time to uniformly mix with the dispersion of core particles.

Therefore, the particle diameter of the core particles, and the adherence rate and strength of the resin particles B vary.

The adherence rate of the resin particles B is determined by the following formula.

Adherence rate of the resin particles B=(Added resin particles B−resin particles B which do not adhere to the core particles)/Added resin particles B

The adherence strength of the resin particles B is an index of releasing difficulty thereof after having adhered to the core particles.

Further, the batch method has the following problem. Namely, quality results are not found until the core particles dispersion process, the convergence process and the resin particles B transfer process are completed. Quality defective products for one batch have been produced when they are found to be defective.

Japanese published unexamined application No. JP-2012-008555-A discloses the following toner preparation method for the purpose of preparing a toner on the surface of which resin particles are uniformly fixed. Namely, a method of preparing a toner including at least core particles including a first resin and a colorant, and resin particles formed of a second resin. The resin particles are partially buried in the core particles and the other resin particles project from the surface thereof.

Japanese published unexamined application No, JP-2012-008555-A is similar to Modified Example in terms of covering the core particles with particles. However, the particle diameter of the core particles, and the adherence rate and strength of the resin particles B still vary.

Japanese Patent No. JP-4154073-B1 (JP-2000-330334-A) discloses the following toner preparation method for the purpose of preparing a toner on the surface of which resin particles are uniformly fixed. Namely, after resin particles and core particles obtained by suspension polymerization methods are mixed and stirred to transfer the resin particles to the core particles. After the core particles the resin particles are transferred to are dispersed in an aqueous medium, the aqueous medium is controlled to have a temperature of from 62 to 90° higher than a glass transition temperature of the core particles while high shearing strength is applied thereto to fix the resin particles on the surfaces of the core particles.

Japanese Patent No. JP-4154073-B1 (JP-2000-330334-A) is similar to Modified Example in terms of covering the core particles with particles. However, the particle diameter of the core particles, and the adherence rate and strength of the resin particles B still vary.

Next, an example of conventional equipment in the resin particles B transfer process is explained.

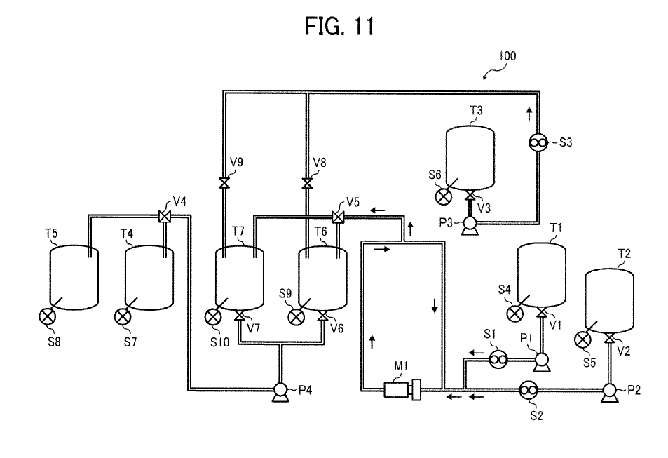

FIG. 11 is a schematic view illustrating a mixer 100 used in conventional toner preparation method.

An oil phase including an organic solvent and at least a resin, a release agent and a colorant dissolved or dispersed therein is in an oil phase tank T1. The oil phase tank T1 includes an oil phase tank liquid surface meter S4 monitoring an amount of the oil phase therein. The oil phase tank T1 forms a feed line to a disperser M1 with a pipe through an oil phase tank bottom valve V1. The oil phase is fed to the disperser M1 by an oil phase feed pump P1 and a flow speed thereof is monitored by an oil phase flow amount meter S1.

An aqueous solvent is in an aqueous solvent tank T2. The aqueous solvent tank T2 includes an aqueous solvent tank liquid surface meter S5 monitoring an amount of the aqueous solvent therein. The aqueous solvent tank T2 forms a feed line to a disperser M1 with a pipe through an aqueous solvent tank bottom valve V2. The aqueous solvent is fed to the disperser M1 by an aqueous solvent feed pump P2 and a flow speed thereof is monitored by an aqueous solvent flow amount meter S2.

The resin particles A are mixed in the aqueous solvent. In the disperser M1, the oil phase and the aqueous solvent are applied with a shearing force to produce a dispersion of core particles including the aqueous solvent and the oil phase dispersed therein.

A line to a first resin particles transfer tank T6 and a second resin particle transfer tank T7 through a resin transfer tank switch valve V5 and a line circulating to the disperser M1 are formed with pipes. The dispersion of core particles produced in the disperser M1 is partially discharged to the resin transfer tank switch valve V5 and the rest circulates a circulation route and reaches the disperser M1, and is further applied with a shearing force. The oil phase and the aqueous solvent are fed from the oil phase tank T1 and the aqueous solvent tank T2, respectively to the circulation route to be discharged to the resin transfer tank switch valve V5 when overflowed.

The dispersion of core particles overflowed from the circulation route of the disperser M1 is placed in the first resin particles transfer tank T6 or the second resin particle transfer tank T7 through the resin transfer tank switch valve V5.

The first resin particles transfer tank T6 includes a first resin particles transfer tank liquid surface meter S9 monitoring an amount of the dispersion of core particles and that of a mixed dispersion therein. The first resin particles transfer tank T6 forms feed lines with pipes to a mixed dispersion tank T4 and a waste liquid tank T5 through a first resin particles transfer tank bottom valve V6. The mixed dispersion is fed from the first resin particles transfer tank T6 to the mixed dispersion tank T4 or the waste liquid tank T5 by a mixed dispersion pump P4.

The second resin particle transfer tank T7 includes a second resin particles transfer tank liquid surface meter S10 monitoring an amount of the dispersion of core particles and that of a mixed dispersion therein. The second resin particles transfer tank T7 forms feed lines with pipes to a mixed dispersion tank T4 and a waste liquid tank T5 through a second resin particles transfer tank bottom valve V7. The mixed dispersion is fed from the second resin particles transfer tank T7 to the mixed dispersion tank T4 or the waste liquid tank T5 by a mixed dispersion pump P4.

The resin particles B or the dispersion of resin particles B is in a resin particles B tank T3. The resin particles B tank T3 includes a resin particles tank liquid surface meter S6 monitoring an amount of the resin particles B or the dispersion of resin particles B. The resin particles B tank T3 forms a feed line to the first resin particles transfer tank T6 with a pipe through a resin particles tank bottom valve V3 and first resin particles placement valve V8. In addition, the resin particles B tank T3 forms a feed line to the second resin particles transfer tank T7 with a pipe through a resin particles tank bottom valve V3 and first resin particles placement valve V9. The resin particles B or the dispersion of resin particles B is fed to the first resin particles transfer tank T6 and the second resin particles transfer tank T7 by a resin particles B feed pump P3 and a feed amount thereof is monitored by a resin particles B flow amount meter S3.

The mixer 100 in FIG. 11 fills the first resin particles transfer tank T6 or the second resin particles transfer tank T7 with the overflowed dispersion of core particles. After the dispersion of core particles is filled therein in a predetermined amount, the resin particles B or the dispersion of resin particles B is placed therein to be mixed with the dispersion of core particles. After mixed, a line is formed with a pipe from each of the first resin particles transfer tank T6 and the second resin particles transfer tank T7 to the mixed dispersion tank T4 or the waste liquid tank T5.

A switch valve V4 switches feeding liquid to the mixed dispersion tank T4 and the waste liquid tank T5 at a branch in the line thereto. The mixed dispersion before quality thereof is stabilized is fed to the waste liquid tank T5. The waste liquid tank T5 includes a waste liquid tank liquid surface meter S8 monitoring an amount of the waste liquid therein. The mixed dispersion after quality thereof is stabilized is fed to the mixed dispersion tank T4. The mixed dispersion tank T4 includes a mixed dispersion tank liquid surface meter S7 monitoring an amount of the mixed dispersion therein.

In the mixer 100 in FIG. 11 mixing by a batch method, the resin particles B or the dispersion of resin particles B is added to the dispersion of core particles after filled in a mixing tank (the first resin particles transfer tank T6 or the second resin particles transfer tank T7) in a predetermined. The resin particles B or the dispersion of resin particles B is added to the core particles having different convergence time (a time after the oil phase was dispersed in the aqueous solvent by the disperser M1). Therefore, the particle diameter of the core particles, and the adherence rate and strength of the resin particles B vary.

The mixer 100 in FIG. 10 adds the resin particles B or the dispersion of resin particles B while the dispersion of core particles is fed to be mixed in the pipe and transfer the resin particles B to the core particles. Thus, the resin particles B or the dispersion of resin particles B can quickly and uniformly be mixed with the dispersion of core particles converged for the same short time to prevent unevenness of particle diameter, and adherence rate and strength of the resin particles B to the core particles.

The mixer 100 in FIG. 11 fills the first resin particles transfer tank T6 or the second resin particles transfer tank T7 with a predetermined amount of the dispersion of core particles. Then, the resin particles B or the dispersion of resin particles B is added and mixed with the dispersion of core particles. Quality is not found until one batch is completed. In the mixer 100 in FIG. 10, quality is can continuously be found to see the mixed dispersion discharged from the mixing element M2. Quality defective products for one batch are not produced even when defectives are found.

The Modified Example may include the oil phase preparation process, the emulsification process, the de-solvent process, the washing and drying process and the external additive application process of the embodiment.

The resin particles B of the Modified Example may be the same as those of the embodiment. In addition, the dispersion stabilizer, the resin added in an organic solvent, the modified resin, the crystalline polyester, the inorganic alkali, the organic solvent, the aqueous medium, the surfactant and the resin particles A included in the aqueous medium of the Modified Example may be the same as those of the embodiment. Further, the protective colloid, the colorant, the release agent and the charge controlling agent of the Modified Example may be the same as those of the embodiment. The colorant of the Modified Example may be combined with a resin as a masterbatch as it is in the embodiment. The masterbatch preparation method may be the same as that of embodiment.

Hereinafter, the toner preparation method of the Modified Example is specifically explained.

Processes from preparation of the dispersion of resin particles A to preparation of the low-molecular-weight polyester solution were the same as those of the embodiment.

### Modified Example 1

Processes from preparation of oil phase to emulsification process were the same as those of Example 1.

### <Resin Particles B Transfer Process>

The emulsified dispersion was fed into the dispersion feeding pipe having an inner diameter of 43 mm at 14.48 kg/min in FIG. 2. A mixture of 30 parts of the dispersion of resin particles B and 45 parts of water was added thereto at 1.448 kg/min. A mixed liquid of the dispersion of colored resin particles and the dispersion of resin particles B was mixed by the fluid stirrer 10 to prepare a dispersion of complex particles. One fifty-one (151) parts (100% by weight relative to a weight of the core particles) of pure water were added to the dispersion of complex particles.

The mixing element M2 in FIG. 10 was not used, and the dispersion of core particles and the dispersion of resin particle B were mixed in a conventional pipe.

### <De-Solvent>

The emulsified dispersion having passed the resin particles B transfer process was placed in a tank made of SUS and equipped with a warm water jacket and a depressure line, and gradually depressurized while stirred by a stirring blade at an outer circumferential speed of 10.5 msec so as not be boiled to prepare a de-solvented slurry.

### <Washing and Drying Process>

The de-solvented slurry was subjected to a pressure-filtration using a filter press to prepare a filtered cake (1). Next, water was added to the filtered cake (1) so that the solid content of the mixture becomes 20% by weight and dispersed by an agitator, and 10% by weight hydrochloric acid was added to the diluted cake agitating the mixture using an agitator until the mixture had a pH of 5.0 and the particles were washed for 30 minutes to prepare a washed liquid. After the washed liquid was subjected to a pressure-filtration using a filter press, followed by a penetration washing to prepare a filtered cake (2). Next, water was added to the filtered cake (2) so that the solid content of the mixture becomes 25% by weight, and the mixture was dispersed using an agitator to prepare a washed slurry (1) having an electroconductivity of 50 μS/cm.

Next, water was added to a third liquid so that the washed slurry (1) had a solid content concentration of 20% by weight, and mixed by an agitator. Then, the 1% by weight methanol/water solution of a charge controlling agent, N,N,N-trimethyl-[3-(4-perfluorononenyloxybenzamide)propyl]ammonium iodide (FUTARGENT 310 from Neos), was added to the washed slurry (1) so that the charge controlling agent is added in an amount of 0.2% by weight based on the solid component of the slurry (1). The mixture was agitated for 30 minutes to prepare mother toner particles. Thus, a slurry (2) including the mother toner particles was prepared. The slurry (2) was then subjected to a centrifugal separation treatment using a centrifugal separator to separate the solid (mother toner particles) from the liquid. The mother toner particles were dried for 24 hours at 40° C. using a decompression dryer.

Next, the following components were mixed using a HENSCHEL MIXER.

| | |
|---|---|
| Mother toner particles prepared above | 100 |
| Hydrophobized titanium oxide | 0.4 |
| Hydrophobized silica | 0.5 |
| (H2000 from Clariant Japan) | |

The mixture was filtered by a screen having openings of 37 μm to remove coarse particles therefrom to prepare a black toner (1a).

These procedures were repeated for 9 times further to totally prepare 10 black toners (1a).

### Modified Example 2

The procedure for preparation of the black toner (1a) was repeated except for changing the inner diameter of the dispersion feeding pipe to 37.1 mm in the resin particles B transfer process to prepare a black toner (2a).

### Modified Example 3

The procedure for preparation of the black toner (1a) was repeated except for using the mixing element M2, which was a static mixer having a length of 150 mm and a diameter same as that of the dispersion feeding pipe after the dispersion of core particles and the resin particles B join together therein in the resin particles B transfer process to prepare a black toner (3a).

### Modified Example 4

The procedure for preparation of the black toner (1a) was repeated except for using the mixing element M2, which was a static mixer having a length of 300 mm and a diameter same as that of the dispersion feeding pipe after the dispersion of core particles and the resin particles B join together therein in the resin particles B transfer process to prepare a black toner (4a).

### Modified Example 5

The procedure for preparation of the black toner (1a) was repeated except for changing the inner diameter of the dispersion feeding pipe to 37.1 mm and using the mixing element M2, which was a static mixer having a length of 150 mm and a diameter same as that of the dispersion feeding pipe after the dispersion of core particles and the resin particles B join together therein in the resin particles B transfer process to prepare a black toner (5a).

### Modified Example 6

The procedure for preparation of the black toner (1a) was repeated except for changing the inner diameter of the dispersion feeding pipe to 37.1 mm and using the mixing element M2, which was a static mixer having a length of 300 mm and a diameter same as that of the dispersion feeding pipe after the dispersion of core particles and the resin particles B join together therein in the resin particles B transfer process to prepare a black toner (6a).

### Comparative Example

The procedure for preparation of the black toner (1a) was repeated except that the emulsified dispersion having passed the resin particles B transfer process was placed in a tank made of SUS, and that a mixture including 30% by weight of the dispersion of resin particles B and 45% by weight of water was added in the tank for 2 min and stirred for 3 min to prepare a black toner (7a).

The measurement results of Modified Examples 1 to 6 are shown in Tables 2-1 to 2-3.

TABLE 2-1

| | Method of | | | Length of | |
|---|---|---|---|---|---|
| | Adding Resin | Pipe | Mixing | Mixing | Twist |
| | Particles B | Diameter | Element | Element | Angle |
| Modified | In Pipe | 43.0 mm | No | — | |
| Example 1 | | | | | |
| Modified | In Pipe | 37.1 mm | No | — | |
| Example 2 | | | | | |
| Modified | In Pipe | 43.0 mm | Yes | 150 mm | 180° |
| Example 3 | | | | | |
| Modified | In Pipe | 43.0 mm | Yes | 300 mm | 180° |
| Example 4 | | | | | |
| Modified | In Pipe | 37.1 mm | Yes | 150 mm | 180° |
| Example 5 | | | | | |
| Modified | In Pipe | 37.1 mm | Yes | 300 mm | 180° |
| Example 6 | | | | | |
| Comparative | In Tank | — | — | — | — |
| Example | | | | | |

TABLE 2-2

| | | | | b | |
|---|---|---|---|---|---|
| | | | | | Unevenness |
| | | | | Resin | of Resin |
| | | a | | Particles B | Particles B |
| | Pitch | | Coarse | Adherence | Adherence |
| | P/D | ΔDv | Particles | Rate | Rate |
| Modified | — | Fair | B | Good | Fair |
| Example 1 | | | | | |
| Modified | — | Good | B | Good | Good |
| Example 2 | | | | | |
| Modified | 1.5 | Good | B | Good | Good |
| Example 3 | | | | | |
| Modified | 1.5 | Good | B | Good | Excellent |
| Example 4 | | | | | |
| Modified | 1.5 | Good | A | Good | Excellent |
| Example 5 | | | | | |
| Modified | 1.5 | Excellent | A | Excellent | Excellent |
| Example 6 | | | | | |
| Comparative | — | Fair | B | Fair | Poor |
| Example | | | | | |

TABLE 2-3

| | c | | d | | |
|---|---|---|---|---|---|
| | | Unevenness | Photo- | e | f |
| | Resin | of Resin | receptor | Fixable | Heat |
| | Particles B | Particles B | back- | Minimum | Resistant |
| | Adherence | Adherence | ground | Temper- | Preserv- |
| | Strength | Strength | fouling | ature | ability |
| Modified | Good | Fair | Fair | Good | Good |
| Example 1 | | | | | |
| Modified | Good | Good | Fair | Good | Good |
| Example 2 | | | | | |
| Modified | Good | Good | Good | Fair | Fair |
| Example 3 | | | | | |
| Modified | Good | Excellent | Good | Good | Good |
| Example 4 | | | | | |
| Modified | Good | Excellent | Good | Good | Good |
| Example 5 | | | | | |
| Modified | Excellent | Excellent | Good | Good | Good |
| Example 6 | | | | | |
| Comparative | Fair | Poor | Fair | Good | Good |
| Example | | | | | |

In Tables 2-1 to 2-3, items except for Method of Adding Resin Particles B and Mixing Element are the same as those in the embodiment and the evaluation methods are the same as well. In Examples 1 to 6 in Tables 1-1 to 1-3, Method of Adding Resin Particles B are all In Pipe, Mixing Element are all Yes, and Length of Mixing Element are all 150 mm.

Modified Examples 1 to 6 do not show Baffle Plate and H/D because of having no baffle plate, and Flow Channel Limiting Plate and Hole, either.

Table 2 proves toners in Modified Examples 1 to 6 in which the resin particles B are transferred in the pipe have better adherence rate and strength thereof than Comparative Example in which they are transferred in the tank.

Further, Table 2 proves each of the pipe and the mixing element preferably has a smaller diameter.

Having now fully described the invention, it will be apparent to one of ordinary skill in the art that many changes and modifications can be made thereto without departing from the spirit and scope of the invention as set forth therein.

What is claimed is:

1. A fluid stirrer, comprising:
a flow channel pipe configured to pass a fluid inside;
a spiral flow forming member configured to guide the fluid to circle around a central axis parallel to a passing direction of the fluid to form a spiral flow in the flow channel pipe; and
a spiral flow baffle member configured to project from the inner wall of the flow channel pipe and disturb the spiral flow.

2. The fluid stirrer of claim 1, wherein the spiral flow forming member is a spiral blade formed of a flat plate twisted around the central axis.

3. The fluid stirrer of claim 2, wherein the spiral flow baffle member is located extending to a passing direction of the fluid with a inclination relative to a twist direction of the spiral blade.

4. The fluid stirrer of claim 1, wherein at least one of the spiral flow forming member and the spiral flow baffle member comprises a hole the fluid is able to pass through.

5. The fluid stirrer of claim 1, further comprising a flow channel cross-section limiting member configured to partially narrow a cross-section of the flow channel pipe perpendicular to the passing direction of the fluid.

6. The fluid stirrer of claim 5, wherein the flow channel cross-section limiting member comprises a hole the fluid is able to pass through.

7. A method of stirring fluid, comprising:
stirring a fluid with the fluid stirrer according to claim 1.

8. A method of preparing toner, comprising:
stirring a fluid comprising toner materials with the fluid stirrer according to claim 1.

9. A method of preparing toner, comprising:
mixing plural fluids comprising toner materials,
wherein one or more second fluids are fed in a pipe where a first fluid is transferred to be mixed therewith.

10. The method of claim 9, further comprising:
dispersing an oil phase comprising:
an organic solvent; and
at least a resin, a release agent and a colorant dissolved or dispersed in the organic solvent,
in an aqueous solvent to prepare a dispersion of core particles which is the first fluid in which core particles comprising the oil phase as a main component are dispersed; and
adding resin particles or a dispersion of resin particles which is the one or more second fluids in the dispersion of core particles to transfer the resin particles to the core particles.

11. The method of claim 9, wherein the fluids are mixed by a fluid stirrer.

12. The method of claim 11, wherein the fluid stirrer is the fluid stirrer according to claim 1.
